(19) United States
(12) Patent Application Publication
(10) Pub. No.: US 2026/0014989 A1
(43) Pub. Date: Jan. 15, 2026

(54) ARTIFICIALLY INTELLIGENT ASSISTANCE OF HAZARDOUS OVERTAKING INITIATIVES

(71) Applicant: Volvo Car Corporation, Göteborg (SE)

(72) Inventors: Zhennan Fei, Gothenburg (SE); Derong Yang, Gothenburg (SE)

(21) Appl. No.: 18/771,143

(22) Filed: Jul. 12, 2024

(51) Int. Cl. B60W 30/18; B60W 40/04; G06V 20/58; H04W 4/46

(52) U.S. Cl. CPC B60W 30/18163; B60W 40/04; G06V 20/58; H04W 4/46; B60W 2720/106; B60W 2720/24; G06V 2201/08

(57) ABSTRACT

Systems/techniques that facilitate artificially intelligent assistance of hazardous overtaking initiatives are provided. In various embodiments, a system can receive one or more electronic notifications broadcasted by a vehicle. In various aspects, the system can detect, via one or more sensors onboard the first vehicle, overtaking intention by a second vehicle of the first vehicle. In various instances, the system can determine, in response to detection of the overtaking intention by the second vehicle, adjustments of a current trajectory of the first vehicle to facilitate completion of overtaking by the second vehicle or deter overtaking by the second vehicle.

### TECHNICAL FIELD

The subject disclosure relates generally to artificial intelligence, and more specifically to artificially intelligent assistance of hazardous overtaking initiatives.

### BACKGROUND

Overtaking refers to the action of one vehicle passing another vehicle traveling in the same direction on a roadway. This maneuver can involve the overtaking vehicle accelerating to a higher speed, moving to a different lane or position, such as to oncoming lanes, to bypass the slower vehicle, and then returning to the original lane or position once a safe distance has been achieved. However, overtaking by vehicles can be prone to causing accidents or collisions, such as with oncoming vehicles. Unfortunately, existing techniques for addressing or preventing hazardous overtaking initiatives can be unreliable.

Accordingly, systems or techniques that can address one or more of these technical problems can be desirable.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus or computer program products that facilitate artificially intelligent assistance of hazardous overtaking initiatives are described.

According to one or more embodiments, a system is provided. The system can be onboard a first vehicle, and the system can comprise a non-transitory computer-readable memory that can store computer-executable components. The system can further comprise a processor that can be operably coupled to the non-transitory computer-readable memory and that can execute the computer-executable components stored in the non-transitory computer-readable memory. In various embodiments, the computer-executable components can comprise a sensor component that can capture, via one or more first cameras or one or more first microphones of the first vehicle, vicinity data associated with a first vicinity of the first vehicle. In various aspects, the computer-executable components can comprise an inference component that can determine, via execution of a deep learning neural network on the vicinity data, whether a vehicular collision not involving the first vehicle has occurred in the first vicinity of the first vehicle. In various instances, the computer-executable components can comprise an evidence component that can record, in response to a determination that the vehicular collision has occurred and via the one or more first cameras or the one or more first microphones, first post-collision evidence associated with the first vicinity of the first vehicle.

According to one or more embodiments, a system is provided. The system can be onboard a vehicle, and the system can comprise a non-transitory computer-readable memory that can store computer-executable components. The system can further comprise a processor that can be operably coupled to the non-transitory computer-readable memory and that can execute the computer-executable components stored in the non-transitory computer-readable memory. In various embodiments, the computer-executable components can comprise a sensor component that can capture, via one or more cameras or one or more microphones of the vehicle, vicinity data associated with a vicinity of the vehicle. In various aspects, the computer-executable components can comprise an inference component that can generate, via execution of a deep learning neural network on the vicinity data, a classification label indicating whether a vehicular collision not involving the vehicle has occurred in the vicinity of the vehicle. In various instances, the computer-executable components can comprise an evidence component that can record, in response to the classification label indicating that the vehicular collision has occurred and via the one or more cameras or the one or more microphones, post-collision evidence associated with the vicinity of the vehicle. In various cases, the computer-executable components can comprise a broadcast component that can broadcast, in response to the classification label indicating that the vehicular collision has occurred, the classification label and the post-collision evidence to an emergency service computing device.

According to one or more embodiments, a system is provided. The system can be onboard a vehicle, and the system can comprise a non-transitory computer-readable memory that can store computer-executable components. The system can further comprise a processor that can be operably coupled to the non-transitory computer-readable memory and that can execute the computer-executable components stored in the non-transitory computer-readable memory. In various embodiments, the computer-executable components can comprise a sensor component that can capture, via one or more cameras or one or more microphones of the vehicle, vicinity data associated with a vicinity of the vehicle. In various aspects, the computer-executable components can comprise an inference component that can determine, via execution of a deep learning neural network on the vicinity data, whether a vehicular collision not involving the vehicle has occurred in the vicinity of the vehicle. In various instances, the computer-executable components can comprise a broadcast component that can broadcast, in response to a determination that the vehicular collision has occurred, via the one or more cameras or the one or more microphones, and to an emergency service computing device, a post-collision live stream associated with the vicinity of the vehicle.

According to one or more embodiments, a system is provided. The system can be onboard a vehicle, and the system can comprise a non-transitory computer-readable memory that can store computer-executable components. The system can further comprise a processor that can be operably coupled to the non-transitory computer-readable memory and that can execute the computer-executable components stored in the non-transitory computer-readable memory. In various embodiments, the computer-executable components can comprise a sensor component that can capture, via one or more cameras or one or more microphones of the vehicle, vicinity data associated with a vicinity of the vehicle. In various aspects, the computer-executable components can comprise an inference component that can determine, via execution of a deep learning neural network on the vicinity data, whether a vehicular collision not involving the vehicle has occurred in the vicinity of the vehicle. In various instances, the computer-executable components can comprise a broadcast component that can broadcast, in response to a determination that the vehicular collision has occurred and via the one or more cameras or the one or more microphones, one or more electronic notifications.

According to one or more embodiments, a system is provided. The system can comprise a non-transitory computer-readable memory that can store computer-executable components. The system can further comprise a processor that can be operably coupled to the non-transitory computer-readable memory and that can execute the computer-executable components stored in the non-transitory computer-readable memory. In various embodiments, the computer-executable components can comprise a receiver component that can receive one or more electronic notifications broadcasted by a vehicle. In various aspects, the computer-executable components can comprise a determination component that can determine, via parsing, whether the one or more electronic notifications indicate that a vehicular collision not involving the vehicle has occurred in a vicinity of the vehicle. In various instances, the computer-executable components can comprise an execution component that can initiate, in response to a determination that the one or more electronic notifications indicate that the vehicular collision has occurred, one or more electronic actions based on the vehicular collision.

According to one or more embodiments, the above-described systems can be implemented as computer-implemented methods or computer program products.

### DESCRIPTION OF THE DRAWINGS

FIG. 1 illustrates an example, non-limiting diagram showing a second vehicle overtaking a first vehicle, where such first vehicle can facilitate artificially intelligent assistance of hazardous overtaking initiatives in accordance with one or more embodiments described herein.

FIG. 2 illustrates a block diagram of an example, non-limiting system that can facilitate artificially intelligent assistance of hazardous overtaking initiatives in accordance with one or more embodiments described herein.

FIG. 3 illustrates a block diagram of an example, non-limiting system including various sensors that facilitates artificially intelligent assistance of hazardous overtaking initiatives in accordance with one or more embodiments described herein.

FIG. 4 illustrates a block diagram of an example, non-limiting system including a deep learning neural network and an overtaking intention label that can facilitate artificially intelligent assistance of hazardous overtaking initiatives in accordance with one or more embodiments described herein.

FIG. 5 illustrates an example, non-limiting block diagram of overtaking vehicle states and oncoming vehicle states in accordance with one or more embodiments described herein.

FIG. 6 illustrates an example, non-limiting block diagram showing how a deep learning neural network can generate the overtaking vehicle states and oncoming vehicle states based on vicinity data in accordance with one or more embodiments described herein.

FIG. 7 illustrates an example, non-limiting block diagram showing how a deep learning neural network can generate an indicator of overtaking intention based on the overtaking vehicle states in accordance with one or more embodiments described herein.

FIG. 8 illustrates a block diagram of an example, non-limiting system including a deep learning neural network and a risk level that can facilitate artificially intelligent assistance of hazardous overtaking initiatives in accordance with one or more embodiments described herein.

FIG. 9 illustrates an example, non-limiting block diagram showing how a deep learning neural network can generate the risk level based on the overtaking vehicle states and oncoming vehicle states in accordance with one or more embodiments described herein.

FIG. 10 illustrates a block diagram of an example, non-limiting system 1000 including a deep learning neural network, adjustments, and a control component that can facilitate artificially intelligent assistance of hazardous overtaking initiatives in accordance with one or more embodiments described herein

FIG. 11 illustrates an example, non-limiting block diagram showing how a deep learning neural network can generate adjustments based on the oncoming vehicle states and in accordance with one or more embodiments described herein.

FIG. 12 illustrates a block diagram of an example, non-limiting system that can facilitate artificially intelligent assistance of hazardous overtaking initiatives in accordance with one or more embodiments described herein.

FIG. 13 illustrates a block diagram of an example, non-limiting system including a network component and an electronic alert that can facilitate artificially intelligent assistance of hazardous overtaking initiatives in accordance with one or more embodiments described herein.

FIG. 14 illustrates a block diagram of an example, non-limiting system including a training component and a training dataset that can facilitate artificially intelligent assistance of hazardous overtaking initiatives in accordance with one or more embodiments described herein.

FIG. 15 illustrates an example, non-limiting block diagram of a training dataset in accordance with one or more embodiments described herein.

FIG. 16 illustrates an example, non-limiting block diagram showing how a deep learning neural network can be trained in accordance with one or more embodiments described herein.

FIG. 17 illustrates a flow diagram of an example, non-limiting computer-implemented method that can facilitate artificially intelligent assistance of hazardous overtaking initiatives in accordance with one or more embodiments described herein.

FIG. 18 illustrates a flow diagram of an example, non-limiting computer-implemented method that can facilitate artificially intelligent assistance of hazardous overtaking initiatives in accordance with one or more embodiments described herein.

FIG. 19 illustrates a flow diagram of an example, non-limiting computer-implemented method that can facilitate artificially intelligent assistance of hazardous overtaking initiatives in accordance with one or more embodiments described herein.

FIG. 20 illustrates a block diagram of an example, non-limiting operating environment in which one or more embodiments described herein can be facilitated.

FIG. 21 illustrates an example networking environment operable to execute various implementations described herein.

### DETAILED DESCRIPTION

The following detailed description is merely illustrative and is not intended to limit embodiments or application/uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Overtaking refers to the action of a second vehicle passing a first vehicle traveling in the same direction on a roadway. This maneuver can involve the second vehicle (e.g., the overtaking vehicle) accelerating to a higher speed, moving to a different lane or position, such as to oncoming lanes, to bypass the slower vehicle, and then returning to the original lane or position once a safe distance has been achieved. However, overtaking by vehicles can be prone to causing accidents or collisions, such as with oncoming traffic (e.g., oncoming vehicles, wildlife on the road, crossing pedestrians, objects on the road). Overtaking by vehicles is a significant cause of traffic accidents (e.g., due to lack of experience by the driver, poor psychological quality, insufficient safety distance, front speed judgement errors, environment conditions). A head-on vehicular collision between the overtaking vehicle and oncoming traffic can cause or otherwise involve vehicle damage (e.g., crumpled bumpers, ruined fenders, broken headlights, bent frames) or bodily injury (e.g., broken bones, lacerations, whiplash).

Unfortunately, existing techniques for facilitating safe completion or deterrence of overtaking by another vehicle can be unreliable for various reasons.

First, existing techniques are typically applicable for assisting the vehicle to overtake a second vehicle. That is, existing techniques focus on behavior and motion planning for autonomous vehicles (AVs) themselves to overtake other vehicles in front. Unfortunately, such methods can be insufficient to improve overall traffic safety. For instance, the second vehicle can attempt to overtake the first vehicle, but such overtaking can prove hazardous to the second vehicle and/or the first vehicle (e.g., due to lack of experience by the driver, presence of incoming traffic). However, existing methods lack capabilities to assist the second vehicle in overtaking the first vehicle.

Second, although some existing techniques utilize deployment of overtaking assistance systems to multiple vehicles (e.g., an autonomous driving (AD) fleet), such techniques often rely on communication between multiple AVs. Accordingly, if the second vehicle is not equipped with AD attempts to overtake a vehicle, existing methods can lack capabilities to assist the second vehicle in overtaking the first vehicle. Further, overtaking can be a complex maneuver involving high risk of collisions. Accordingly, AD-assisted overtaking is not frequently implemented in AD systems (e.g., as unsupervised AD features).

Accordingly, systems or techniques that can address one or more of these technical problems can be desirable.

Various embodiments described herein can address one or more of these technical problems. One or more embodiments described herein can include systems, computer-implemented methods, apparatus, or computer program products that can facilitate artificially intelligent assistance of hazardous overtaking initiatives. That is, various disadvantages associated with existing techniques for facilitating safe completion or deterrence of overtaking by another vehicle can be ameliorated by artificially intelligent assistance of hazardous overtaking initiatives. More specifically, a first vehicle can be outfitted with various external sensors, such as road-facing cameras or road-facing microphones. In various aspects, the first vehicle can utilize such external sensors to capture vicinity data of a vicinity of the first vehicle (e.g., to capture pictures of roadways, sidewalks, pedestrians, or other vehicles that are in the vicinity of the first vehicle, to capture noises that occur in the vicinity of the first vehicle). Furthermore, the first vehicle can be outfitted with a deep learning neural network that can be trained or otherwise configured to determine if there is overtaking intention be a second vehicle of the first vehicle. Moreover, the first vehicle can be outfitted with a second deep learning neural network that can be trained or otherwise configured to determine a risk level of the overtaking by the second vehicle based on detected oncoming vehicles. Thus, in various instances, the first vehicle can be outfitted with a third deep learning neural network that can be trained or otherwise configured to determine adjustments to a current trajectory of the first vehicle to facilitate completion or deterrence of overtaking by the second vehicle based on the risk level. Therefore, in various aspects, the first vehicle can execute such adjustments to cause safe completion of overtaking by the second vehicle of the first vehicle, or safe deterrence of overtaking by the second vehicle of the first vehicle. In this way, such embodiments can be considered as effectively improving overall traffic safety in connection with overtaking by other vehicles.

Various embodiments described herein can be considered as a computerized tool (e.g., any suitable combination of computer-executable hardware or computer-executable software) that can facilitate artificially intelligent assistance of hazardous overtaking initiatives. In various aspects, there can be a vehicle. In various instances, the vehicle can be outfitted with a computerized tool. In various cases, the computerized tool can comprise a sensor component, an inference component, a recognition component, or an adaptation component.

In various embodiments, the sensor component of the computerized tool can electronically record, measure, or otherwise capture vicinity data associated with a vicinity of the vehicle. More specifically, the sensor component can electronically access or otherwise control various sensors of the vehicle. Such sensors can include one or more cameras of the vehicle, one or more microphones of the vehicle, or one or more proximity sensors (e.g., radar, sonar, lidar) of the vehicle. In various aspects, the sensor component can leverage such sensors to obtain the vicinity data. For example, the one or more cameras can capture one or more images of the vicinity of the vehicle (e.g., images of roadways, sidewalks, traffic lights, buildings, pedestrians, trees, or other vehicles that are within any suitable distance in front of the vehicle, behind the vehicle, or beside the vehicle). As another example, the one or more microphones can record one or more noises that occur in the vicinity of the vehicle (e.g., noises that occur within any suitable distance in front of the vehicle, behind the vehicle, or beside the vehicle). As still another example, the one or more proximity sensors can measure one or more proximity detections associated with the vicinity (e.g., can detect tangible objects that are within any suitable distance in front of the vehicle, behind the vehicle, or beside the vehicle). In various cases, such one or more images, such one or more noises, or such one or more proximity detections can collectively be considered as the vicinity data.

In various embodiments, the recognition component of the computerized tool can electronically store, maintain, control, or otherwise access a first deep learning neural network. In various aspects, the recognition component can execute (after training) the first deep learning neural network on the vicinity data, thereby yielding the states of the second vehicle or the oncoming vehicle. In various aspects, the recognition component can further execute (after training) the first deep learning neural network on the states of the second vehicle or the oncoming vehicle, thereby yielding an indicator of overtaking intention by the second vehicle.

In various embodiments, the inference component of the computerized tool can electronically store, maintain, control, or otherwise access a second deep learning neural network. In various aspects, the inference component can execute (after training) the second deep learning neural network on the states of the second vehicle or the oncoming vehicle, thereby yielding a risk level associated with overtaking by the second vehicle based on the oncoming vehicles.

In various embodiments, the adaptation component of the computerized tool can electronically store, maintain, control, or otherwise access a third deep learning neural network. In various aspects, the adaptation component can execute (after training) the third deep learning neural network on the states of the oncoming vehicle, thereby yielding a set of adjustments of a current trajectory of the first vehicle that facilitate completion of overtaking by the second vehicle or deter overtaking by the second vehicle. Deterring the second vehicle can comprise performing actions that cause the second vehicle to refrain from or stop overtaking of the first vehicle before completing the overtaking (e.g., changes lanes to overtake then moves back to their original position). In various aspects, a control component of the computerized tool can execute the adjustments determined by the adaptation component.

Various embodiments described herein can be employed to use hardware or software to solve problems that are highly technical in nature (e.g., to facilitate artificially intelligent assistance of hazardous overtaking initiatives), that are not abstract and that cannot be performed as a set of mental acts by a human. Further, some of the processes performed can be performed by a specialized computer (e.g., a deep learning neural network having internal parameters such as convolutional kernels) for carrying out defined tasks related to artificially intelligent traffic analysis of oncoming vehicles and overtaking by vehicles.

For example, such defined tasks can include: detecting, by a system operatively coupled to a processor, onboard a first vehicle, overtaking intention by a second vehicle of the first vehicle via one or more sensors onboard the first vehicle; and determining, by the system and in response to detection of the overtaking intention by the second vehicle, adjustments of a current trajectory of the first vehicle to facilitate completion of overtaking by the second vehicle or deter overtaking by the second vehicle.

Such defined tasks are not performed manually by humans. Indeed, neither the human mind nor a human with pen and paper can: electronically capture, measure, or otherwise record vicinity data using vehicle sensors (e.g., cameras, microphones, or proximity sensors); electronically generate states of a second vehicle or oncoming vehicles; electronically detect a overtaking intention by the second vehicle by executing a deep learning neural network on the states; and electronically determine adjustments to a current trajectory of a first vehicle to facilitate completion of overtaking by the second vehicle of the first vehicle or deter overtaking by the second vehicle of the first vehicle. Indeed, vehicle sensors and deep learning neural networks are inherently-computerized devices that simply cannot be implemented in any way by the human mind without computers. Accordingly, a computerized tool that can control vehicle sensors and that can train or execute a deep learning neural network on data captured by such vehicle sensors is likewise inherently-computerized and cannot be implemented in any sensible, practical, or reasonable way without computers.

Moreover, various embodiments described herein can integrate into a practical application various teachings relating to artificially intelligent assistance of hazardous overtaking initiatives. As explained above, some existing techniques rely upon AD assistance to help the vehicle itself overtake other vehicles. Further, as explained above, some existing techniques frequently do not implement AD-assisted overtaking due to the complexity and risk associated with overtaking maneuvers. However, such methods do not provide capabilities to improve overall traffic safety by assisting other vehicles attempting to overtake. These can be considered as various disadvantages of existing techniques.

Various embodiments described herein can address various of these disadvantages. Specifically, various embodiments described herein can include outfitting a vehicle with a computerized tool, where such computerized tool can: detects, via one or more sensors (e.g., cameras, microphones, proximity detectors) onboard the first vehicle, overtaking intention by a second vehicle of the first vehicle; and determine, in response to detection of the overtaking intention by the second vehicle, adjustments of a current trajectory of the first vehicle to facilitate completion of overtaking by the second vehicle or deter overtaking by the second vehicle. Such embodiments can more reliably improve overall traffic safety, as compared to various existing techniques. In some cases, the computerized tool can even communicate, via Vehicle-to-Vehicle (V2V) communication, with oncoming vehicles to request deceleration of the oncoming vehicles. Accordingly, various embodiments can help to ameliorate various disadvantages of existing techniques. Thus, various embodiments described herein certainly constitute a concrete and tangible technical improvement. Therefore, various embodiments described herein clearly qualify as useful and practical applications of computers.

Furthermore, various embodiments described herein can control real-world tangible devices based on the disclosed teachings. For example, various embodiments described herein can electronically control real-world vehicle sensors (e.g., real-world vehicle cameras, real-world vehicle microphones, real-world vehicle proximity detectors), can electronically execute (or train) real-world deep learning neural networks on data captured by such real-world vehicle sensors, and can electronically control operation of real-world vehicles based on the data captured by such real-world vehicle sensors.

It should be appreciated that the herein figures and description provide non-limiting examples of various embodiments and are not necessarily drawn to scale.

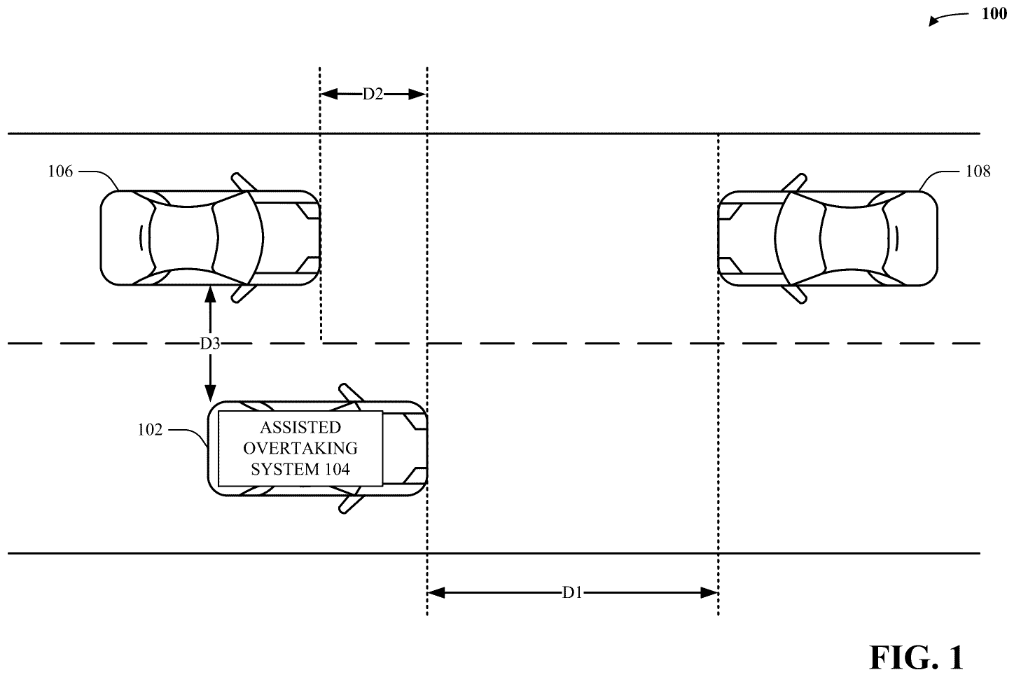

FIG. 1 illustrates an example, non-limiting diagram 100 showing a second vehicle overtaking a first vehicle, where such first vehicle can facilitate artificially intelligent assistance of hazardous overtaking initiatives in accordance with one or more embodiments described herein.

In various embodiments, there can be a vehicle 102. In various aspects, the vehicle 102 can be any suitable vehicle or automobile (e.g., can be a car, a truck, a van, a motorcycle). In various instances, the vehicle 102 can have or otherwise exhibit any suitable type of propulsion system (e.g., can be an electric vehicle, can be a gasoline-powered or diesel-powered vehicle, can be a hybrid vehicle). In some cases, the vehicle 102 can be driving on any suitable road, street, lane, or highway at any suitable speed. In other cases, the vehicle 102 can, while driving, be stopped at an intersection, at a traffic light, at a stop sign, at a cross-walk, or at a traffic jam.

In any case, the vehicle 102 can comprise, have, or otherwise be outfitted or equipped with an assisted overtaking system 104. In other words, the assisted overtaking system 104 can be onboard the vehicle 102. In various aspects, the assisted overtaking system 104 can, as described herein, electronically monitor a vicinity of the vehicle 102 for vehicles that may overtake vehicle 102 or oncoming vehicles. In some cases, because the vehicle 102 can comprise the assisted overtaking system 104, the vehicle 102 can be considered as a smart vehicle. In various instances, the vehicle 102 can be an autonomous vehicle (AV) that can be equipped with an automated driving system (ADS).

In various aspects, there can be a vehicle 106. In various aspects, the vehicle 106 can be any suitable vehicle or automobile (e.g., can be a car, a truck, a van, a motorcycle). In various instances, the vehicle 106 can have or otherwise exhibit any suitable type of propulsion system (e.g., can be an electric vehicle, can be a gasoline-powered or diesel-powered vehicle, can be a hybrid vehicle). In some cases, the vehicle 106 can be driving on any suitable road, street, lane, or highway at any suitable speed. In various instances, the vehicle 106 can be any suitable distance away from the vehicle 102 (e.g., can be within mere feet of the vehicle 102). In various cases, the vehicle 106 can attempt to overtake or initiate overtaking of vehicle 102.

In various aspects, there can be an oncoming vehicle 108. In various aspects, the oncoming vehicle 108 can be any suitable vehicle or automobile (e.g., can be a car, a truck, a van, a motorcycle). In various instances, the oncoming vehicle 108 can have or otherwise exhibit any suitable type of propulsion system (e.g., can be an electric vehicle, can be a gasoline-powered or diesel-powered vehicle, can be a hybrid vehicle). In some cases, the oncoming vehicle 108 can be driving on any suitable road, street, lane, or highway at any suitable speed. In various instances, the oncoming vehicle 108 can be any suitable distance away from the vehicle 102 (e.g., can be within mere feet of the vehicle 102) and be driving in opposite directions as vehicle 102 (e.g., driving towards vehicle 102 in the opposite lane). In various cases, the vehicle 106 can be driving towards oncoming vehicle 108 while attempting to overtake vehicle 102. In various instances, there can be more than one oncoming vehicle 108 approaching vehicle 102 (e.g., two motorcycles occupying the opposite lane).

As a non-limiting example, vehicle 106 can initiate overtaking of vehicle 102 and there can be oncoming vehicle 108. In such instance, the lateral distance between vehicle 102 and oncoming vehicle 108 can be denoted by D1. D1 can define the lateral distance between the front of vehicle 102 and the front of vehicle 108. Moreover, the lateral distance between vehicle 102 and vehicle 106 can be denoted by D2. D2 can define the lateral distance between the front of vehicle 102 and the front of vehicle 106. Furthermore, the longitudinal distance between vehicle 102 and vehicle 106 can be denoted by D3. D3 can define the longitudinal distance between the side of vehicle 102 (e.g., the side of vehicle 102 facing vehicle 106) and the side of vehicle 106 (e.g., the side of vehicle 106 facing vehicle 102). Such distances can be utilized by assisted overtaking system 104 to determine adjustments of a current trajectory of vehicle 102 to facilitate completion of overtaking by vehicle 106 of vehicle 102 or deter overtaking by vehicle 106 of vehicle 102. Note that, this is a mere non-limiting example and any suitable defined lateral and longitudinal distances between vehicle 102, vehicle 106, and oncoming vehicle 108 can be utilized. For instance, the lateral distance D2 between vehicle 102 and vehicle 106 can be defined as the lateral distance between the rear of vehicle 102 and the rear of vehicle 106.

In various aspects, the vicinity can be any suitable physical area that encompasses the immediate or nearby surroundings of vehicle 102. In other words, the vicinity can be any suitable physical area or physical space that is within any suitable threshold distance in front of, beside, or behind the vehicle 102. In various instances, the vicinity can be considered as encompassing whatever surroundings happen to be near the vehicle 102 at any given instant in time. Accordingly, depending upon a current e.g., vehicle 106, oncoming vehicle 108), one or more street lanes, one or more street curbs (not shown), one or more highway medians (not shown), one or more sidewalks (not shown), one or more ditches or other off-road portions (not shown), one or more pedestrians (not shown), one or more animals (not shown), or any other suitable objects or fixtures (e.g., power poles, street lamps, street signs, fire hydrants, mailboxes, bus stops, benches, objects in the roadway).

In any case, as described herein, the assisted overtaking system 104 can continually or periodically scan, using vehicle sensors and deep learning, the vicinity for other vehicles. As described herein, the assisted overtaking system 104 can be considered as regularly monitoring the vicinity for vehicles that may overtake vehicle 102 or oncoming vehicles. When vehicle 106 initiates overtaking of vehicle 102, the assisted overtaking system 104 can, as described herein, automatically detect the overtaking intention by vehicle 106 of vehicle 102. Upon such detection, the assisted overtaking system 104 can, as described herein, automatically detect oncoming vehicles (e.g., oncoming vehicle 108). Furthermore, in response to detecting overtaking intention by vehicle 106 and oncoming vehicle 108, the assisted overtaking system 104 can, as described herein, determine a risk level of the oncoming vehicle 108. In particular, the assisted overtaking system 104 can determine if the overtaking by vehicle 106 of vehicle 102 is risky (e.g., vehicle 106 may not complete the overtaking of vehicle 102 before reaching oncoming vehicle 108, there is risk of collision between vehicle 106 and oncoming vehicle 108) or not risky (e.g., there are no oncoming vehicles, vehicle 106 has sufficient distance to complete overtaking of vehicle 102 before reaching vehicle 108, there is no risk of collision between vehicle 106 and oncoming vehicle 108) based on states of vehicle 106 and oncoming vehicle 108. In some cases, in response to a determination that the overtaking is risky, the assisted overtaking system 104 can determine and execute adjustments to the current trajectory of vehicle 102 to facilitate completion of overtaking by vehicle 106 or deter overtaking by vehicle 106. Conversely, in various instances, in response to a determination that the overtaking is not risky, the assisted overtaking system 104 can refrain from determining and executing adjustments to the current trajectory of vehicle 102. In particular, if the assisted overtaking system 104 determines that overtaking by vehicle 106 of vehicle 102 cannot be safely completed, the adjustments to the current trajectory of vehicle 102 can be determined such that it deters vehicle 106 from continuing overtaking of vehicle 102 (e.g., accelerating to deter vehicle 106 from overtaking, moving towards the opposite lane to deter vehicle 106 from overtaking). In other cases, if the assisted overtaking system 104 determines that overtaking by vehicle 106 of vehicle 102 can be safely completed, the adjustments to the current trajectory of vehicle 102 can be determined such that it facilitates completion of overtaking by vehicle 106 (e.g., decelerating, moving away from the opposite lane).

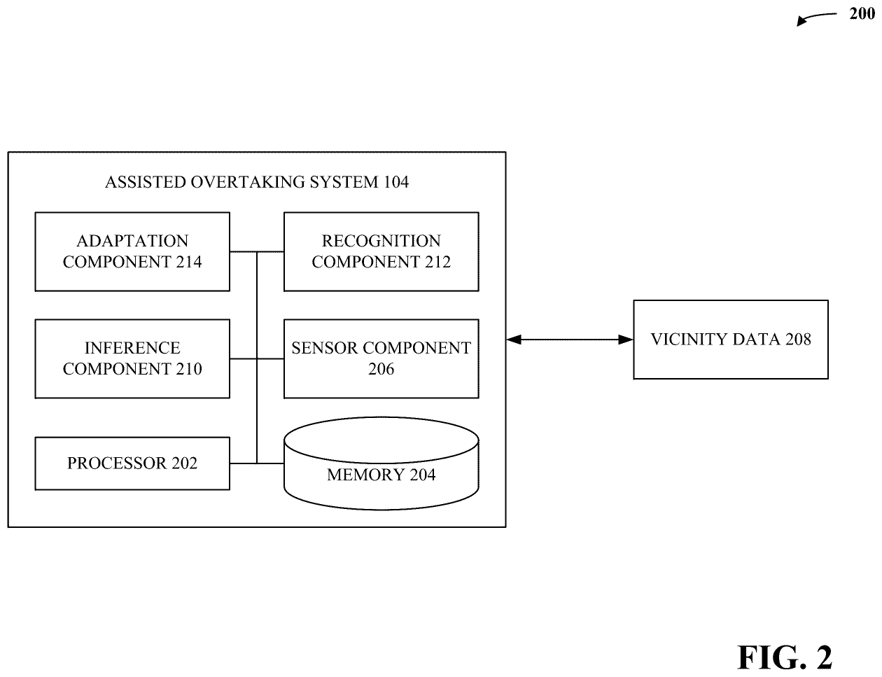

FIG. 2 illustrates a block diagram of an example, non-limiting system 200 that can facilitate artificially intelligent assistance of hazardous overtaking initiatives in accordance with one or more embodiments described herein. In other words, FIG. 2 depicts a non-limiting example embodiment of the assisted overtaking system 104.

In various embodiments, the assisted overtaking system 104 can comprise a processor 202 (e.g., computer processing unit, microprocessor) and a non-transitory computer-readable memory 204 that is operably or operatively or communicatively connected or coupled to the processor 202. The non-transitory computer-readable memory 204 can store computer-executable instructions which, upon execution by the processor 202, can cause the processor 202 or other components of the assisted overtaking system 104 (e.g., sensor component 206, inference component 210, recognition component 212, adaptation component 214) to perform one or more acts. In various embodiments, the non-transitory computer-readable memory 204 can store computer-executable components (e.g., sensor component 206, inference component 210, recognition component 212, adaptation component 214), and the processor 202 can execute the computer-executable components.

In various embodiments, the assisted overtaking system 104 can comprise a sensor component 206. In various aspects, as described herein, the sensor component 206 can obtain, via any suitable sensors of the vehicle 102, vicinity data 208. In various cases, the vicinity data 208 can exhibit any suitable format, size, or dimensionality. For example, the vicinity data 208 can comprise one or more scalars, one or more vectors, one or more matrices, one or more tensors, one or more character strings, or any suitable combination thereof.

In various embodiments, the assisted overtaking system 104 can comprise a recognition component 212. In various cases, as described herein, the recognition component 212 can detect, via one or more sensors onboard the first vehicle (e.g., sensor component 206), overtaking intention by vehicle 106 of vehicle 102. In various embodiments, the recognition component 212 can further detect, via the one or more sensors, oncoming vehicles (e.g., vehicle 108).

In various embodiments, the assisted overtaking system 104 can comprise an adaptation component 214. In various cases, as described herein, the adaptation component 214 can determine, in response to detection of the overtaking intention by vehicle 106, adjustments of a current trajectory of vehicle 102 to facilitate completion of overtaking by the vehicle 106 or deter overtaking by the vehicle 106.

In various embodiments, the assisted overtaking system 104 can comprise an inference component 210. In various instances, as described herein, the inference component 210 can infer a risk level of the oncoming vehicles. In various aspects, the inference component 210 can refrain from engaging the adaptation component 214 in response to an inference that there is no risk from the oncoming vehicles, thereby refraining from triggering the adjustments of the current trajectory. Conversely, the inference component 210 can proceed with engaging the adaptation component 214 in response to an inference that there is no risk from the oncoming vehicles, thereby refraining from triggering the adjustments of the current trajectory

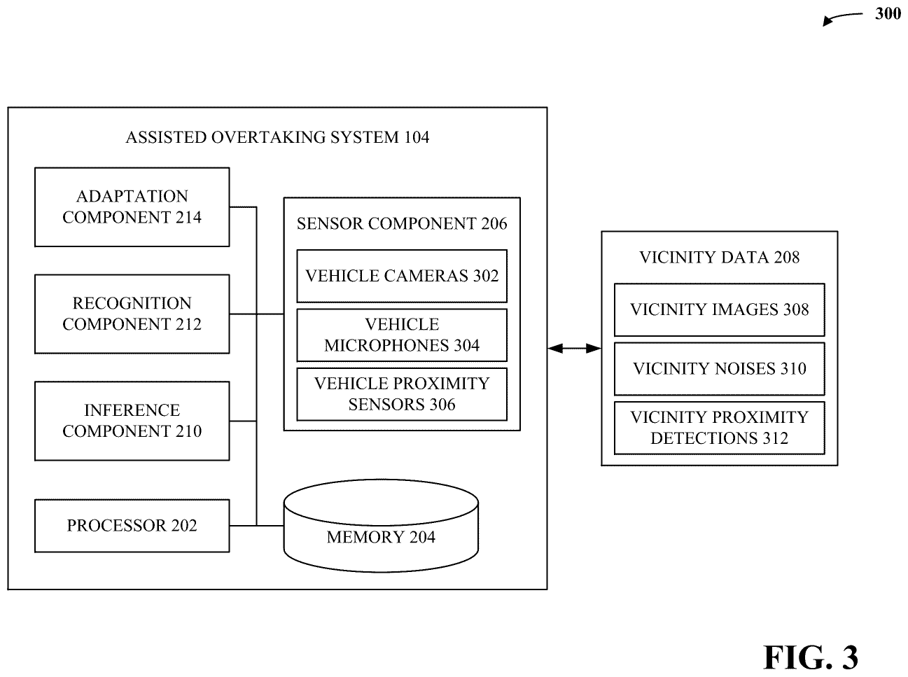

FIG. 3 illustrates a block diagram of an example, non-limiting system 300 including various sensors that can facilitate artificially intelligent assistance of hazardous overtaking initiatives in accordance with one or more embodiments described herein.

In various embodiments, the sensor component 206 can electronically control, electronically execute, electronically activate, or otherwise electronically access any suitable sensors of the vehicle 102. In various aspects, such sensors can be external or road-facing. In other words, such sensors can be oriented or otherwise configured to monitor a vicinity (e.g., the surroundings of the vehicle 102) as the vehicle 102 drives around.

As a non-limiting example, such sensors can include a set of vehicle cameras 302. In various aspects, the set of vehicle cameras 302 can include any suitable number of any suitable types of cameras (e.g., of image-capture devices). In various instances, the set of vehicle cameras 302 can be integrated into or onto the vehicle 102. In various cases, one or more of the set of vehicle cameras 302 can be forward-facing. For example, such one or more cameras can be integrated into or onto any suitable forward-facing surfaces, whether interior or exterior, of the vehicle 102 (e.g., can be built on a dash of the vehicle 102 so as to look through a front windshield of the vehicle 102, can be built around the front windshield of the vehicle 102, can be built into a front bumper of the vehicle 102, can be built around headlights of the vehicle 102, can be built into a hood of the vehicle 102). Because such one or more cameras can be forward-facing, such one or more cameras can be configured to capture or otherwise record images or video frames of portions of the vicinity that lie in front of the vehicle 102. In various aspects, one or more of the set of vehicle cameras 302 can be rearward-facing. For example, such one or more cameras can be integrated into or onto any suitable rearward-facing surfaces, whether interior or exterior, of the vehicle 102 (e.g., can be built into or on a rearview mirror of the vehicle 102, can be built into or onto sideview mirrors of the vehicle 102, can be built around a rear windshield of the vehicle 102, can be built into a rear bumper of the vehicle 102, can be built around taillights of the vehicle 102, can be built into a trunk-cover of the vehicle 102). Because such one or more cameras can be rearward-facing, such one or more cameras can be configured to capture or otherwise record images or video frames of portions of the vicinity that lie behind the vehicle 102. In various instances, one or more of the set of vehicle cameras 302 can be laterally-facing. For example, such one or more cameras can be integrated into or onto any suitable lateral surfaces, whether interior or exterior, of the vehicle 102 (e.g., can be built into or around doors or door handles of the vehicle 102, can be built into or around fenders of the vehicle 102). Because such one or more cameras can be laterally-facing, such one or more cameras can be configured to capture or otherwise record images or video frames of portions of the vicinity that lie beside the vehicle 102.

As another non-limiting example, such sensors can include a set of vehicle microphones 304. In various aspects, the set of vehicle microphones 304 can include any suitable number of any suitable types of microphones (e.g., of sound-capture devices). In various instances, the set of vehicle microphones 304 can be integrated into or onto the vehicle 102. In various cases, one or more of the set of vehicle microphones 304 can be forward-facing. For example, such one or more microphones can be integrated into or onto any suitable forward-facing surfaces, whether interior or exterior, of the vehicle 102, so as to capture or otherwise record sounds or noises that occur in portions of the vicinity that lie in front of the vehicle 102. In various aspects, one or more of the set of vehicle microphones 304 can be rearward-facing. For example, such one or more microphones can be integrated into or onto any suitable rearward-facing surfaces, whether interior or exterior, of the vehicle 102, so as to capture or otherwise record sounds or noises that occur in portions of the vicinity that lie behind the vehicle 102. In various instances, one or more of the set of vehicle microphones 304 can be laterally-facing. For example, such one or more microphones can be integrated into or onto any suitable lateral surfaces, whether interior or exterior, of the vehicle 102, so as to capture or otherwise record sounds or noises that occur in portions of the vicinity that lie beside the vehicle 102.

As still another non-limiting example, such sensors can include a set of vehicle proximity sensors 306. In various aspects, the set of vehicle proximity sensors 306 can include any suitable number of any suitable types of proximity sensors (e.g., of radar, sonar, or lidar sensors). In various instances, the set of vehicle proximity sensors 306 can be integrated into or onto the vehicle 102. In various cases, one or more of the set of vehicle proximity sensors 306 can be forward-facing. For example, such one or more proximity sensors can be integrated into or onto any suitable forward-facing surfaces, whether interior or exterior, of the vehicle 102, so as to capture or otherwise record proximities of tangible objects located in portions of the vicinity that lie in front of the vehicle 102. In various aspects, one or more of the set of vehicle proximity sensors 306 can be rearward-facing. For example, such one or more proximity sensors can be integrated into or onto any suitable rearward-facing surfaces, whether interior or exterior, of the vehicle 102, so as to capture or otherwise record proximities of tangible objects located in portions of the vicinity that lie behind the vehicle 102. In various instances, one or more of the set of vehicle proximity sensors 306 can be laterally-facing. For example, such one or more proximity sensors can be integrated into or onto any suitable lateral surfaces, whether interior or exterior, of the vehicle 102, so as to capture or otherwise record proximities of tangible objects located in portions of the vicinity that lie beside the vehicle 102.

In any case, the sensor component 206 can utilize such sensors to capture, record, or otherwise measure the vicinity data 208.

For example, the set of vehicle cameras 302 can capture a set of vicinity images 308 while the vehicle 102 is driving. In various aspects, the set of vicinity images 308 can include any suitable number of images or video frames (e.g., any suitable number of two-dimensional pixel arrays) that can depict portions of the vicinity (e.g., portions of the vicinity that lie in front of, behind, or beside the vehicle 102).

As another example, the set of vehicle microphones 304 can capture a set of vicinity noises 310 while the vehicle 102 is driving. In various instances, the set of vicinity noises 310 can include any suitable number of audio clips that can represent noises occurring in portions of the vicinity (e.g., in portions of the vicinity that lie in front of, behind, or beside the vehicle 102).

As even another example, the set of vehicle proximity sensors 306 can capture a set of vicinity proximity detections 312 while the vehicle 102 is driving. In various aspects, the set of vicinity proximity detections 312 can include any suitable number of proximity detections (e.g., of radar, sonar, or lidar detections) that can represent distances between the vehicle 102 and nearby objects located in portions of the vicinity (e.g., in portions of the vicinity that lie in front of, behind, or beside the vehicle 102).

Although not explicitly shown in the figures, any of the set of vehicle cameras 302, any of the set of vehicle microphones 304, or any of the set of vehicle proximity sensors 306 can be integrated into or onto a drone (e.g., an autonomous or remotely-operated drone) that can be launched by, controlled by, or otherwise associated with the vehicle 102. For example, the vehicle 102 can launch an air-based or ground-based drone, and such drone can travel along with the vehicle 102 (e.g., can travel in front of the vehicle 102, behind the vehicle 102, or beside the vehicle 102). As such drone travels along with the vehicle 102, such drone can utilize any suitable sensors (e.g., cameras, microphones, proximity sensors) integrated into or onto the drone to monitor the vicinity. In various cases, such drone can electronically transmit (e.g., via a P2P communication link) any data captured by its sensors back to the vehicle 102, and such captured data can be considered as part of the vicinity data 208.

In any case, the set of vicinity images 308, the set of vicinity noises 310, and the set of vicinity proximity detections 312 can collectively be considered as the vicinity data 208.

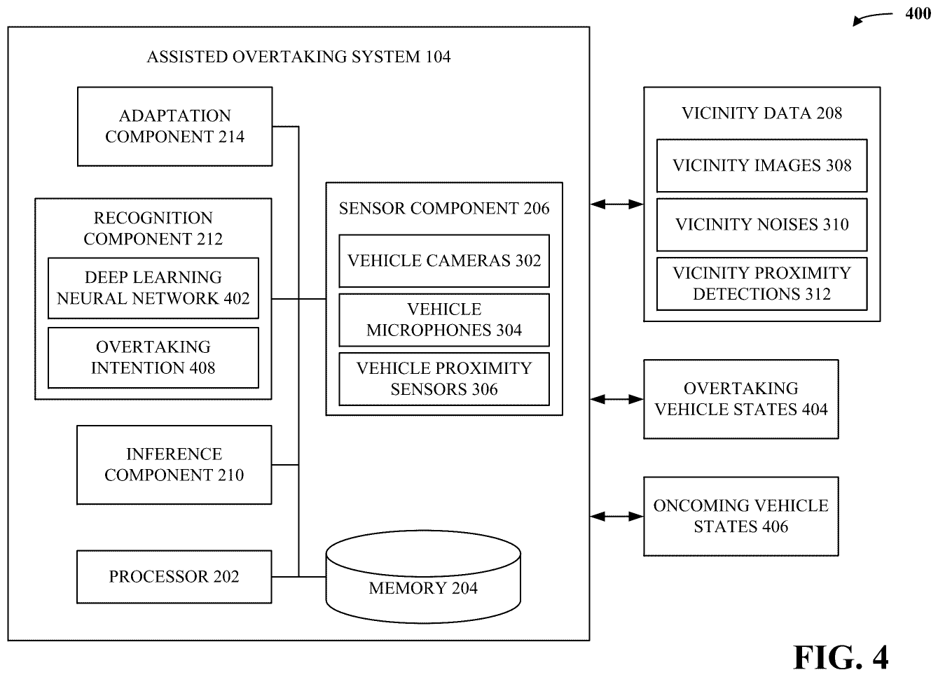

FIG. 4 illustrates a block diagram of an example, non-limiting system 400 including a deep learning neural network and an overtaking intention label that can facilitate artificially intelligent assistance of hazardous overtaking initiatives in accordance with one or more embodiments described herein. As shown, the system 400 can, in some cases, comprise the same components as the system 300, and can further comprise a deep learning neural network 402 or an overtaking intention label 408 (e.g., overtaking intention 408).

In various embodiments, the recognition component 212 can electronically store, electronically maintain, electronically control, or otherwise electronically access the deep learning neural network 402. In various aspects, the deep learning neural network 402 can have or otherwise exhibit any suitable internal architecture. For instance, the deep learning neural network 402 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be convolutional layers, whose learnable or trainable parameters can be convolutional kernels. As another example, any of such input layer, one or more hidden layers, or output layer can be dense layers, whose learnable or trainable parameters can be weight matrices or bias values. As still another example, any of such input layer, one or more hidden layers, or output layer can be batch normalization layers, whose learnable or trainable parameters can be shift factors or scale factors. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers.

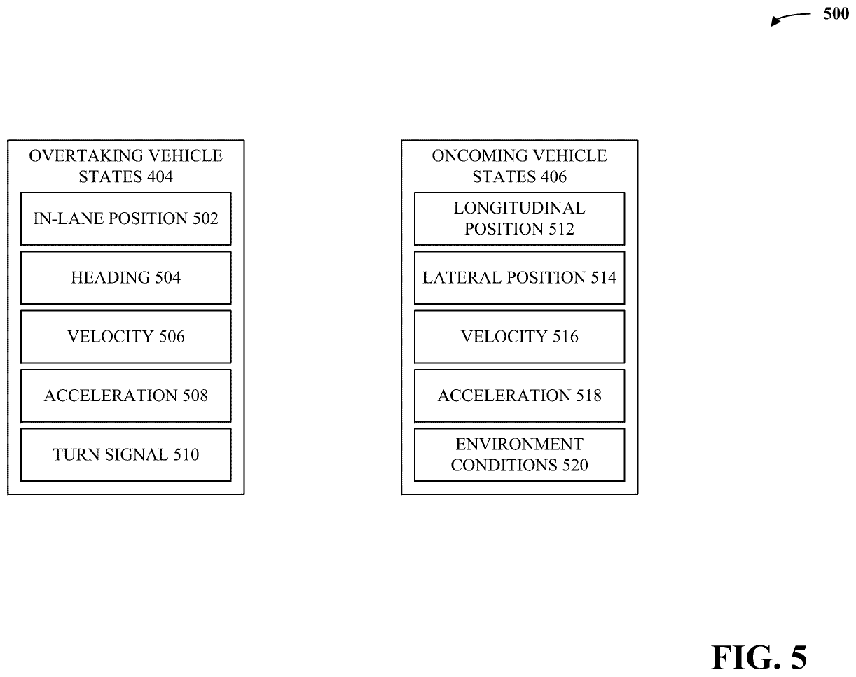

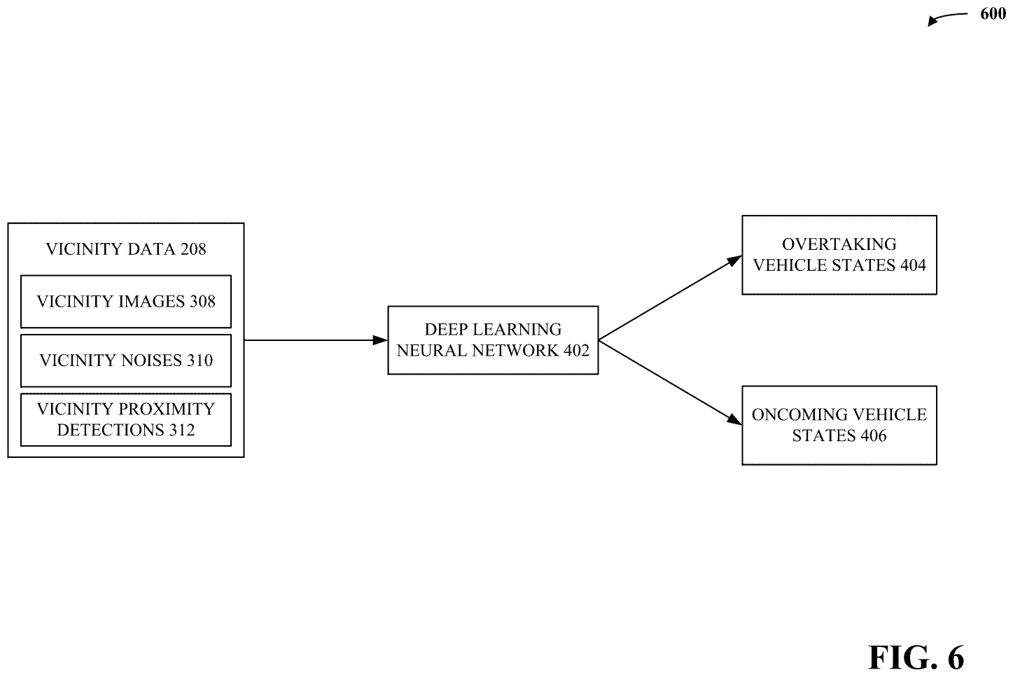

No matter the internal architecture of the deep learning neural network 402, the deep learning neural network 402 can be configured to detect states of vehicle 106 and/or oncoming vehicle 108. Accordingly, the recognition component 212 can electronically execute the deep learning neural network 402 on the vicinity data 208, thereby yielding the overtaking vehicle states 404 and oncoming vehicle states 406. Various non-limiting aspects are described with respect to FIG. 5-6.

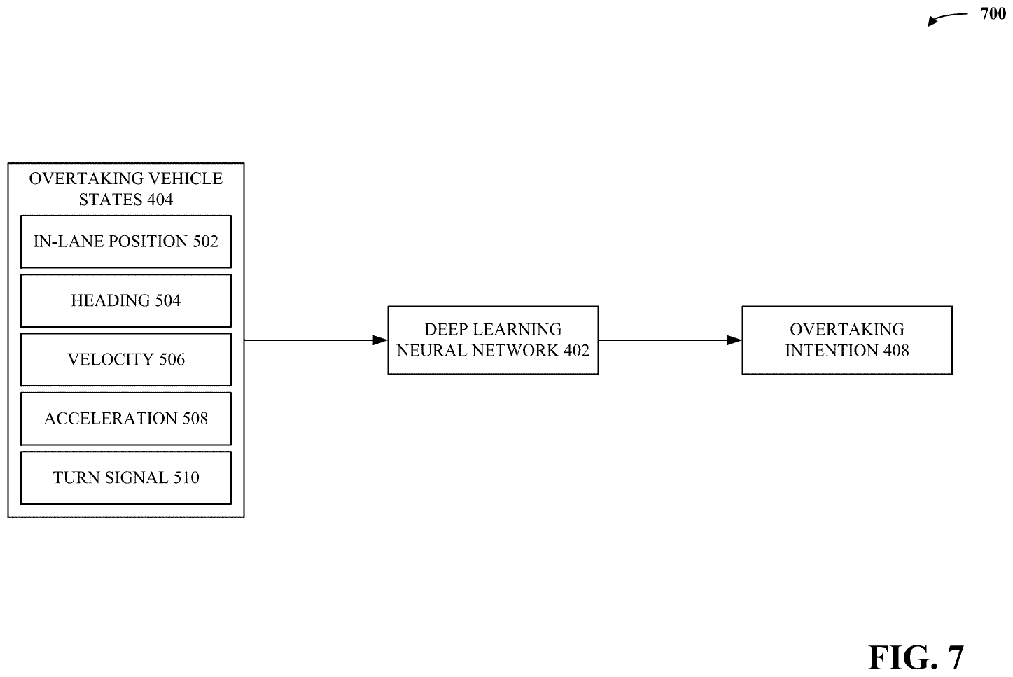

In various embodiments, the deep learning neural network 402 can be configured to determine the overtaking intention 408 by vehicle 106 based on the overtaking vehicle states 404. Accordingly, the recognition component 212 can electronically execute the deep learning neural network 402 on the overtaking vehicle states 404, thereby yielding the overtaking intention 408 indicator. Various non-limiting aspects are described with respect to FIG. 7.

FIG. 5 illustrates an example, non-limiting block diagram 500 of overtaking vehicle states and oncoming vehicle states in accordance with one or more embodiments described herein. That is, FIG. 5 depicts a non-limiting example embodiment of the overtaking vehicle states 404 and the oncoming vehicle states 406.

In various aspects, as shown, the overtaking vehicle states 404 can comprise an in-lane position 502. In various instances, the in-lane position 502 can have any suitable format, size, or dimensionality. That is, the in-lane position 502 can be one or more scalars, one or more vectors, one or more matrices, one or more tensors, one or more character strings, or any suitable combination thereof. In any case, the in-lane position 502 can indicate, convey, or otherwise represent a position of vehicle 106 relative to vehicle 102 in the lane by which vehicle 106 is overtaking vehicle 102. For instance, the sensor component 206 can capture the vicinity data 208 when the vehicle 102 is at a given geolocation, and the deep learning neural network 402 can be trained or otherwise configured, as described herein, to determine, based on the vicinity data 208, a position of vehicle 106 relative to the given geolocation. In other words, if vehicle 106 is detected by vehicle 102, some manifestation of the position of vehicle 106 can be conveyed in the vicinity data 208 (e.g., vehicle 106 can be depicted in the set of vicinity images 308, distinctive sounds of vehicle 106 can be captured in the set of vicinity noises 310, vehicle 106 can cause a distinctive anomaly in the set of vicinity proximity detections 312), and the deep learning neural network 402 can recognize such manifestation of the position of vehicle 106. In any case, the in-lane position 502 can represent the determination, inference, or conclusion generated by the deep learning neural network 402 with respect to the position of vehicle 106 relative to vehicle 102.

As a non-limiting example, the in-lane position 502 can be a variable that can take on one or more possible continuous values. In such case, the one or more possible continuous values can respectively represent any suitable geographical position or distance of vehicle 106. For instance, the in-lane position 502 can represent coordinates (e.g., such as latitude or longitude) or a distance between vehicle 106 and vehicle 102 (e.g., lateral distance D2, longitudinal distance D3).

In various aspects, as shown, the overtaking vehicle states 404 can comprise a heading 504. In various instances, the heading 504 can have any suitable format, size, or dimensionality. That is, the heading 504 can be one or more scalars, one or more vectors, one or more matrices, one or more tensors, one or more character strings, or any suitable combination thereof. In any case, the heading 504 can indicate, convey, or otherwise represent which direction vehicle 106 is facing. For instance, the sensor component 206 can capture the vicinity data 208 when the vehicle 102 is at a given geolocation, and the deep learning neural network 402 can be trained or otherwise configured, as described herein, to determine, based on the vicinity data 208, which direction vehicle 106 is driving. In other words, if vehicle 106 is detected by vehicle 102, some manifestation of which direction vehicle 106 is driving can be conveyed in the vicinity data 208 (e.g., vehicle 106 can be depicted in the set of vicinity images 308, distinctive sounds of vehicle 106 can be captured in the set of vicinity noises 310, vehicle 106 can cause a distinctive anomaly in the set of vicinity proximity detections 312), and the deep learning neural network 402 can recognize such manifestation of which direction vehicle 106 is facing. In any case, the heading 504 can represent the determination, inference, or conclusion generated by the deep learning neural network 402 with respect to which direction vehicle 106 is facing.

As a non-limiting example, the heading 504 can be a multinomial variable that can take on one or more possible discrete states. In such case, the one or more possible continuous values can respectively represent any suitable direction of vehicle 106. For instance, the heading 504 can have a “North” state, a “East” state, a “South” state, a “West” state, a “Northeast” state, a “Southeast” state, a “Northwest” state, or a “Southwest” state. As another non-limiting example, the heading 504 can be a variable that can take on one or more possible continuous values. In such case, the one or more possible continuous values can respectively represent any suitable direction that vehicle 106 is facing. For instance, the heading 504 can represent the precise bearing in degrees of vehicle 106 with respect to a reference direction.

In various aspects, as shown, the overtaking vehicle states 404 can comprise a velocity 506. In various instances, the velocity 506 can have any suitable format, size, or dimensionality. That is, the velocity 506 can be one or more scalars, one or more vectors, one or more matrices, one or more tensors, one or more character strings, or any suitable combination thereof. In any case, the velocity 506 can indicate, convey, or otherwise represent the velocity at which vehicle 106 is driving. For instance, the sensor component 206 can capture the vicinity data 208 when the vehicle 102 is at a given geolocation, and the deep learning neural network 402 can be trained or otherwise configured, as described herein, to determine, based on the vicinity data 208, the velocity of vehicle 106. In other words, if vehicle 106 is detected by vehicle 102, some manifestation of the velocity of vehicle 106 can be conveyed in the vicinity data 208 (e.g., vehicle 106 can be depicted in the set of vicinity images 308, distinctive sounds of vehicle 106 can be captured in the set of vicinity noises 310, vehicle 106 can cause a distinctive anomaly in the set of vicinity proximity detections 312), and the deep learning neural network 402 can recognize such manifestation of the velocity of vehicle 106. In any case, the velocity 506 can represent the determination, inference, or conclusion generated by the deep learning neural network 402 with respect to the velocity of vehicle 106.

As a non-limiting example, the velocity 506 can be a variable that can take on one or more possible continuous values. In such case, the one or more possible continuous values can respectively represent any suitable velocity of vehicle 106. For instance, the velocity 506 can be a scalar whose magnitude represents the velocity of vehicle 106.

In various aspects, as shown, the overtaking vehicle states 404 can comprise a acceleration 508. In various instances, the acceleration 508 can have any suitable format, size, or dimensionality. That is, the acceleration 508 can be one or more scalars, one or more vectors, one or more matrices, one or more tensors, one or more character strings, or any suitable combination thereof. In any case, the acceleration 508 can indicate, convey, or otherwise represent the acceleration of vehicle 106. For instance, the sensor component 206 can capture the vicinity data 208 when the vehicle 102 is at a given geolocation, and the deep learning neural network 402 can be trained or otherwise configured, as described herein, to determine, based on the vicinity data 208, the acceleration of vehicle 106. In other words, if vehicle 106 is detected by vehicle 102, some manifestation of the acceleration of vehicle 106 can be conveyed in the vicinity data 208 (e.g., vehicle 106 can be depicted in the set of vicinity images 308, distinctive sounds of vehicle 106 can be captured in the set of vicinity noises 310, vehicle 106 can cause a distinctive anomaly in the set of vicinity proximity detections 312), and the deep learning neural network 402 can recognize such manifestation of the acceleration of vehicle 106. In any case, the acceleration 508 can represent the determination, inference, or conclusion generated by the deep learning neural network 402 with respect to the acceleration of vehicle 106.

As a non-limiting example, the acceleration 508 can be a variable that can take on one or more possible continuous values. In such case, the one or more possible continuous values can respectively represent any suitable acceleration of vehicle 106. For instance, the acceleration 508 can be a scalar whose magnitude represents the acceleration of vehicle 106.

In various aspects, as shown, the overtaking vehicle states 404 can comprise a turn signal 510. In various instances, the turn signal 510 can have any suitable format, size, or dimensionality. That is, the turn signal 510 can be one or more scalars, one or more vectors, one or more matrices, one or more tensors, one or more character strings, or any suitable combination thereof. In any case, the turn signal 510 can indicate, convey, or otherwise represent whether a turn signal of vehicle 106 is activated. For instance, the sensor component 206 can capture the vicinity data 208 when the vehicle 102 is at a given geolocation, and the deep learning neural network 402 can be trained or otherwise configured, as described herein, to determine, based on the vicinity data 208, whether vehicle 106 has activated a turn signal. In other words, if vehicle 106 has activated a turn signal, some manifestation of the activated turn signal of vehicle 106 can be conveyed in the vicinity data 208 (e.g., vehicle 106 can be depicted in the set of vicinity images 308, vehicle 106 can cause a distinctive anomaly in the set of vicinity proximity detections 312), and the deep learning neural network 402 can recognize such manifestation of the activated turn signal of vehicle 106. Conversely, if vehicle 106 has not activated a turn signal (e.g., no activated turn signal would be depicted in the set of vicinity images 308), and the deep learning neural network 402 can recognize such lack of manifestation of an activated turn signal. In any of these cases, the turn signal 510 can represent the determination, inference, or conclusion generated by the deep learning neural network 402 with respect to whether the turn signals of vehicle 106 have been activated.

As a non-limiting example, the turn signal 510 can be a binary or binomial variable that can take on one of two possible discrete states. In such case, one of the two possible discrete states can represent an “on” state, whereas the other of the two possible discrete states can represent an “off” state. That is, the turn signal 510 can take on the “on” state when the deep learning neural network 402 infers that the turn signals of vehicle 106 are activated, and the turn signal 510 can take on the “off” state when the deep learning neural network 402 instead infers that the turn signals of vehicle 106 are not activated. As another non-limiting example, the turn signal 510 can be a scalar whose magnitude (e.g., ranging continuously from 0 to 1) represents a likelihood or probability that vehicle 106 has activated turn signals (or that vehicle 106 does not have activated turn signals).

In various aspects, as shown, the oncoming vehicle states 404 can comprise a longitudinal position 512. In various instances, the longitudinal position 512 can have any suitable format, size, or dimensionality. That is, the longitudinal position 512 can be one or more scalars, one or more vectors, one or more matrices, one or more tensors, one or more character strings, or any suitable combination thereof. In any case, the longitudinal position 512 can indicate, convey, or otherwise represent a longitudinal position of oncoming vehicle 108 relative to vehicle 102 or vehicle 106. For instance, the sensor component 206 can capture the vicinity data 208 when the vehicle 102 is at a given geolocation, and the deep learning neural network 402 can be trained or otherwise configured, as described herein, to determine, based on the vicinity data 208, a position of oncoming vehicle 108 relative to the given geolocation. In other words, if oncoming vehicle 108 is detected by vehicle 102, some manifestation of the longitudinal position of oncoming vehicle 108 can be conveyed in the vicinity data 208 (e.g., vehicle 106 can be depicted in the set of vicinity images 308, distinctive sounds of oncoming vehicle 108 can be captured in the set of vicinity noises 310, vehicle 106 can cause a distinctive anomaly in the set of vicinity proximity detections 312), and the deep learning neural network 402 can recognize such manifestation of the longitudinal position of oncoming vehicle 108. In any case, the longitudinal position 512 can represent the determination, inference, or conclusion generated by the deep learning neural network 402 with respect to the longitudinal position of oncoming vehicle 108 relative to vehicle 102 or vehicle 106.

As a non-limiting example, the longitudinal position 512 can be a variable that can take on one or more possible continuous values. In such case, the one or more possible continuous values can respectively represent any suitable geographical position or distance of oncoming vehicle 108. For instance, the longitudinal position 512 can represent coordinates, a longitudinal distance between oncoming vehicle 108 and vehicle 102, or a longitudinal distance between oncoming vehicle 108 and vehicle 106. As yet another non-limiting example, the longitudinal position 512 can be a scalar whose magnitude represents a longitudinal distance (e.g., longitudinal distance D1) between oncoming vehicle 108 and vehicle 102.

In various aspects, as shown, the oncoming vehicle states 404 can comprise a lateral position 514. In various instances, the lateral position 514 can have any suitable format, size, or dimensionality. That is, the lateral position 514 can be one or more scalars, one or more vectors, one or more matrices, one or more tensors, one or more character strings, or any suitable combination thereof. In any case, the lateral position 514 can indicate, convey, or otherwise represent a lateral position of oncoming vehicle 108 relative to vehicle 102 or vehicle 106. For instance, the sensor component 206 can capture the vicinity data 208 when the vehicle 102 is at a given geolocation, and the deep learning neural network 402 can be trained or otherwise configured, as described herein, to determine, based on the vicinity data 208, a position of oncoming vehicle 108 relative to the given geolocation. In other words, if oncoming vehicle 108 is detected by vehicle 102, some manifestation of the lateral position of oncoming vehicle 108 can be conveyed in the vicinity data 208 (e.g., vehicle 106 can be depicted in the set of vicinity images 308, distinctive sounds of oncoming vehicle 108 can be captured in the set of vicinity noises 310, vehicle 106 can cause a distinctive anomaly in the set of vicinity proximity detections 312), and the deep learning neural network 402 can recognize such manifestation of the lateral position of oncoming vehicle 108. In any case, the lateral position 514 can represent the determination, inference, or conclusion generated by the deep learning neural network 402 with respect to the lateral position of oncoming vehicle 108 relative to vehicle 102 or vehicle 106.

As a non-limiting example, the lateral position 514 can be a variable that can take on one or more possible continuous values. In such case, the one or more possible continuous values can respectively represent any suitable geographical position or distance of oncoming vehicle 108. For instance, the lateral position 514 can represent coordinates, a lateral distance between oncoming vehicle 108 and vehicle 102, or a lateral distance between oncoming vehicle 108 and vehicle 106. As yet another non-limiting example, the lateral position 514 can be a scalar whose magnitude represents a lateral distance between oncoming vehicle 108 and vehicle 102.

In various aspects, as shown, the oncoming vehicle states 404 can comprise a velocity 516. In various instances, the velocity 516 can have any suitable format, size, or dimensionality. That is, the velocity 516 can be one or more scalars, one or more vectors, one or more matrices, one or more tensors, one or more character strings, or any suitable combination thereof. In any case, the velocity 516 can indicate, convey, or otherwise represent the velocity at which vehicle 106 is driving. For instance, the sensor component 206 can capture the vicinity data 208 when the vehicle 102 is at a given geolocation, and the deep learning neural network 402 can be trained or otherwise configured, as described herein, to determine, based on the vicinity data 208, the velocity of oncoming vehicle 108. In other words, if oncoming vehicle 108 is detected by vehicle 102, some manifestation of the velocity of oncoming vehicle 108 can be conveyed in the vicinity data 208 (e.g., vehicle 106 can be depicted in the set of vicinity images 308, distinctive sounds of oncoming vehicle 108 can be captured in the set of vicinity noises 310, vehicle 106 can cause a distinctive anomaly in the set of vicinity proximity detections 312), and the deep learning neural network 402 can recognize such manifestation of the velocity of oncoming vehicle 108. In any case, the velocity 516 can represent the determination, inference, or conclusion generated by the deep learning neural network 402 with respect to the velocity of oncoming vehicle 108.

As a non-limiting example, the velocity 516 can be a variable that can take on one or more possible continuous values. In such case, the one or more possible continuous values can respectively represent any suitable velocity of oncoming vehicle 108. For instance, the velocity 516 can be a scalar whose magnitude represents the velocity of oncoming vehicle 108.

In various aspects, as shown, the oncoming vehicle states 404 can comprise a acceleration 518. In various instances, the acceleration 518 can have any suitable format, size, or dimensionality. That is, the acceleration 518 can be one or more scalars, one or more vectors, one or more matrices, one or more tensors, one or more character strings, or any suitable combination thereof. In any case, the acceleration 518 can indicate, convey, or otherwise represent the acceleration of oncoming vehicle 108. For instance, the sensor component 206 can capture the vicinity data 208 when the vehicle 102 is at a given geolocation, and the deep learning neural network 402 can be trained or otherwise configured, as described herein, to determine, based on the vicinity data 208, the acceleration of oncoming vehicle 108. In other words, if oncoming vehicle 108 is detected by vehicle 102, some manifestation of the acceleration of oncoming vehicle 108 can be conveyed in the vicinity data 208 (e.g., vehicle 106 can be depicted in the set of vicinity images 308, distinctive sounds of oncoming vehicle 108 can be captured in the set of vicinity noises 310, vehicle 106 can cause a distinctive anomaly in the set of vicinity proximity detections 312), and the deep learning neural network 402 can recognize such manifestation of the acceleration of oncoming vehicle 108. In any case, the acceleration 518 can represent the determination, inference, or conclusion generated by the deep learning neural network 402 with respect to the acceleration of oncoming vehicle 108.

As a non-limiting example, the acceleration 518 can be a variable that can take on one or more possible continuous values. In such case, the one or more possible continuous values can respectively represent any suitable acceleration of oncoming vehicle 108. For instance, the acceleration 518 can be a scalar whose magnitude represents the acceleration of oncoming vehicle 108.

In various aspects, as shown, the oncoming vehicle states 404 can comprise environment conditions 520. In various instances, the environment conditions 520 can have any suitable format, size, or dimensionality. That is, the environment conditions 520 can be one or more scalars, one or more vectors, one or more matrices, one or more tensors, one or more character strings, or any suitable combination thereof. In any case, the environment conditions 520 can indicate, convey, or otherwise represent any environment conditions within a vicinity of vehicle 102. For instance, the sensor component 206 can capture the vicinity data 208 when the vehicle 102 is at a given geolocation, and the deep learning neural network 402 can be trained or otherwise configured, as described herein, to determine, based on the vicinity data 208, the environment conditions within a vicinity of vehicle 102. In other words, if an environment condition is detected (e.g., snow, ice, rainfall), some manifestation of the activated turn signal of oncoming vehicle 108 can be conveyed in the vicinity data 208 (e.g., rainfall can be depicted in the set of vicinity images 308, distinctive sounds of rainfall can be captured in the set of vicinity noises 310, rainfall can cause a distinctive anomaly in the set of vicinity proximity detections 312), and the deep learning neural network 402 can recognize such manifestation of the environment condition. In any case, the environment conditions 520 can represent the determination, inference, or conclusion generated by the deep learning neural network 402 with respect to environment conditions within a vicinity of vehicle 102.

As a non-limiting example, the environment conditions 520 can be a multinomial variable that can take on one or more possible discrete states. For instance, the environment conditions 520 can have a “rain-present” state, an “ice-present” state, a “fog-present” state, a “snow-present” state, or a “clear-environment” state.

In any case, the inference component 210 can execute the deep learning neural network 802 on the overtaking vehicle states 404 and/or the oncoming vehicle states 406, thereby yielding the risk level 804.

FIG. 6 illustrates an example, non-limiting block diagram 600 showing how the deep learning neural network 402 can generate the overtaking vehicle states 404 and oncoming vehicle states 406 based on the vicinity data 208 in accordance with one or more embodiments described herein.

As shown, the recognition component 212 can, in various aspects, execute the deep learning neural network 402 on the vicinity data 208, and such execution can cause the deep learning neural network 402 to produce the overtaking vehicle states 404 or oncoming vehicle states 406. More specifically, the recognition component 212 can feed the vicinity data 208 (e.g., the set of vicinity images 308, the set of vicinity noises 310, or the set of vicinity proximity detections 312) to an input layer of the deep learning neural network 402. In various instances, the vicinity data 208 (e.g., the set of vicinity images 308, the set of vicinity noises 310, or the set of vicinity proximity detections 312) can complete a forward pass through one or more hidden layers of the deep learning neural network 402. In various cases, an output layer of the deep learning neural network 402 can compute the overtaking vehicle states 404 and oncoming vehicle states 406, based on activation maps or intermediate features produced by the one or more hidden layers.

In various aspects, the overtaking vehicle states 404 can be any suitable electronic data exhibiting any suitable format, size, or dimensionality. That is, the overtaking vehicle states 404 can be one or more scalars, one or more vectors, one or more matrices, one or more tensors, one or more character strings, or any suitable combination thereof. In various instances, the sensor component 206 can capture, measure, or otherwise record the vicinity data 208 when the vehicle 102 is at any given geolocation (e.g., when the vicinity is at that given geolocation), and the overtaking vehicle states 404 can indicate, specify, convey, or otherwise represent various states of a vehicle (e.g., vehicle 106) that is overtaking vehicle 102. In some cases, if a vehicle has been detected by vehicle 102, then the overtaking vehicle states 404 can further indicate, specify, convey, or otherwise represent any suitable characteristics, attributes, or properties of such vehicle. Various non-limiting aspects are described with respect to FIG. 6.

In various aspects, the oncoming vehicle states 406 can be any suitable electronic data exhibiting any suitable format, size, or dimensionality. That is, the oncoming vehicle states 406 can be one or more scalars, one or more vectors, one or more matrices, one or more tensors, one or more character strings, or any suitable combination thereof. In various instances, the sensor component 206 can capture, measure, or otherwise record the vicinity data 208 when the vehicle 102 is at any given geolocation (e.g., when the vicinity is at that given geolocation), and the oncoming vehicle states 406 can indicate, specify, convey, or otherwise represent various states of an oncoming vehicle (e.g., oncoming vehicle 108) with respect to vehicle 102 or vehicle 106. In some cases, if an oncoming vehicle has been detected by vehicle 102, then the oncoming vehicle states 406 can further indicate, specify, convey, or otherwise represent any suitable characteristics, attributes, or properties of such vehicle.

FIG. 7 illustrates an example, non-limiting block diagram 700 showing how the deep learning neural network 402 can generate the indicator of overtaking intention 408 based on the overtaking vehicle states 404 in accordance with one or more embodiments described herein.

As shown, the recognition component 212 can, in various aspects, execute the deep learning neural network 402 on the overtaking vehicle states 404, and such execution can cause the deep learning neural network 402 to produce the overtaking intention 408. More specifically, the recognition component 212 can feed the overtaking vehicle states 404 (e.g., in-lane position 502, heading 504, velocity 506, acceleration 508, turn signal 510) to an input layer of the deep learning neural network 402. In various instances, the overtaking vehicle states 404 (e.g., in-lane position 502, heading 504, velocity 506, acceleration 508, turn signal 510) can complete a forward pass through one or more hidden layers of the deep learning neural network 402. In various cases, an output layer of the deep learning neural network 402 can compute the overtaking intention 408, based on activation maps or intermediate features produced by the one or more hidden layers.

In various aspects, the overtaking intention 408 can be any suitable electronic data exhibiting any suitable format, size, or dimensionality. That is, the overtaking intention 408 can be one or more scalars, one or more vectors, one or more matrices, one or more tensors, one or more character strings, or any suitable combination thereof. In various instances, the overtaking intention 408 can indicate, specify, convey, or otherwise represent whether there is overtaking intention by vehicle 106.

As a non-limiting example, the overtaking intention 408 can be a binary or binomial variable that can take on one of two possible discrete states. In such case, one of the two possible discrete states can represent a “is-overtaking” state, whereas the other of the two possible discrete states can represent an “is-not-overtaking” state. That is, the overtaking intention 408 can take on the “is-overtaking” state when the deep learning neural network 402 infers that vehicle 106 is initiating or attempting to overtake vehicle 102, and the overtaking intention 408 can take on the “is-not-overtaking” state when the deep learning neural network 402 instead infers that vehicle 106 is not initiating or attempting to overtake vehicle 102. As another non-limiting example, the overtaking intention 408 can be a scalar whose magnitude (e.g., ranging continuously from 0 to 1) represents a likelihood or probability that vehicle 106 is initiating or attempting to overtake vehicle 102 (or that vehicle 106 is not initiating or attempting to overtake vehicle 102).

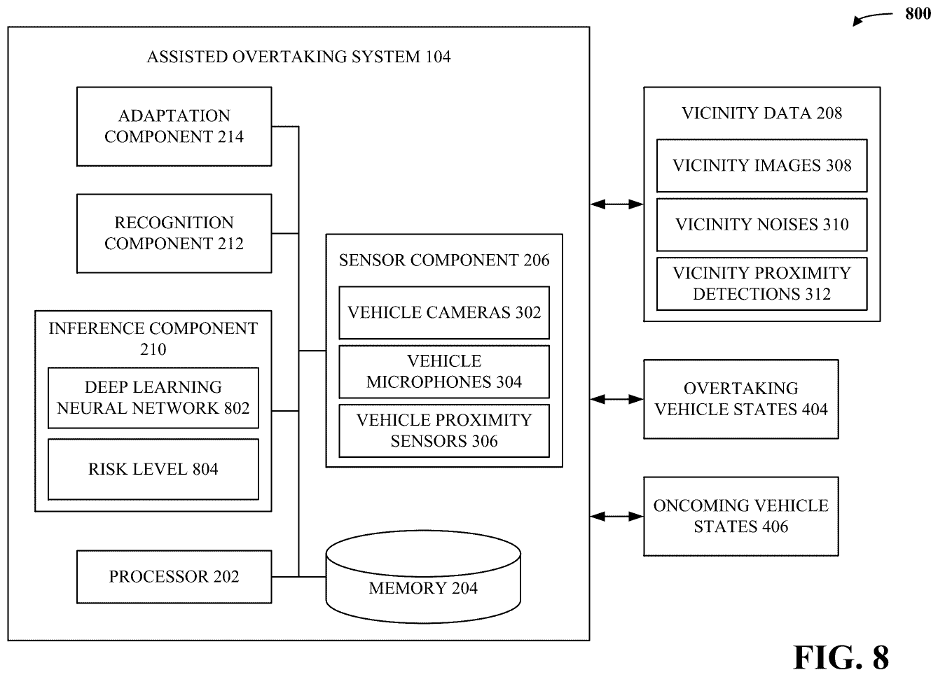

FIG. 8 illustrates a block diagram of an example, non-limiting system 800 including a deep learning neural network and a risk level that can facilitate artificially intelligent assistance of hazardous overtaking initiatives in accordance with one or more embodiments described herein. As shown, the system 800 can, in some cases, comprise the same components as the system 400, and can further comprise deep learning neural network 802 or a risk level 804.

In various embodiments, the inference component 210 can electronically store, electronically maintain, electronically control, or otherwise electronically access the deep learning neural network 802. In various aspects, the deep learning neural network 802 can have or otherwise exhibit any suitable internal architecture. For instance, the deep learning neural network 802 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be convolutional layers, whose learnable or trainable parameters can be convolutional kernels. As another example, any of such input layer, one or more hidden layers, or output layer can be dense layers, whose learnable or trainable parameters can be weight matrices or bias values. As still another example, any of such input layer, one or more hidden layers, or output layer can be batch normalization layers, whose learnable or trainable parameters can be shift factors or scale factors. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers.

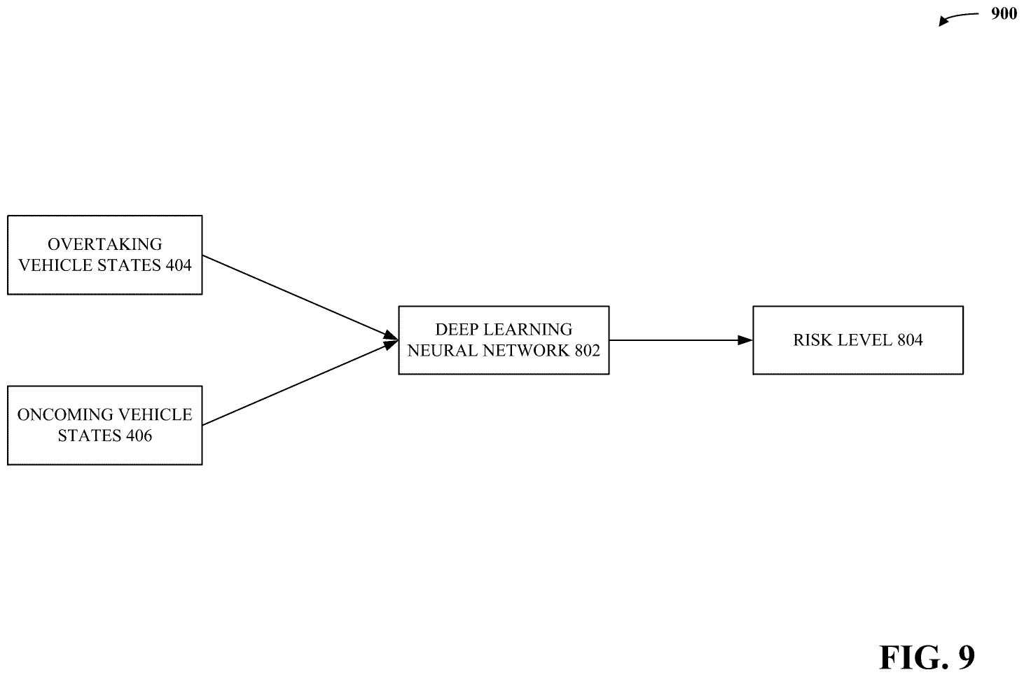

No matter the internal architecture of the deep learning neural network 802, the deep learning neural network 802 can be configured to determine a risk level of the oncoming vehicle 108. That is, the deep learning neural network 802 can be configured to determine risk level 804 associated with the overtaking by vehicle 106 based on overtaking vehicle states 404 or oncoming vehicle states 406. Accordingly, the inference component 210 can electronically execute the deep learning neural network 802 on the overtaking vehicle states 404 or oncoming vehicle states 406, thereby yielding the risk level 804. In response to an inference of risk level 804, the adaptation component 214 can electronically determine adjustments, based on the risk level 804 or based on the oncoming vehicle states 406, of the current trajectory of vehicle 102. Particularly, for instance, if risk level 804 is determined to be low risk, the adaptation component 214 can electronically determine adjustments that facilitate completion of overtaking by vehicle 106 of vehicle 102. Conversely, if risk level 804 is determined to be high risk, the adaptation component 214 can electronically determine adjustments that deter overtaking by vehicle 106 of vehicle 102. In this way, the vehicle 102 can be considered as safely facilitating completion of overtaking by vehicle 106 or deterring overtaking by vehicle 106. Various non-limiting aspects are described with respect to FIG. 9.

FIG. 9 illustrates an example, non-limiting block diagram 900 showing how the deep learning neural network 802 can generate the risk level 804 based on the overtaking vehicle states 404 and oncoming vehicle states 406 in accordance with one or more embodiments described herein.

As shown, the inference component 210 can, in various aspects, execute the deep learning neural network 802 on the overtaking vehicle states 404 and/or oncoming vehicle states 406, and such execution can cause the deep learning neural network 802 to produce the risk level 804. More specifically, the inference component 210 can feed the overtaking vehicle states 404 and/or oncoming vehicle states 406 (e.g., in-lane position 502, heading 504, velocity 506, acceleration 508, turn signal 510, longitudinal position 512, lateral position 514, velocity 516, acceleration 518, environment conditions 520) to an input layer of the deep learning neural network 802. In various instances, the overtaking vehicle states 404 and/or oncoming vehicle states 406 (e.g., in-lane position 502, heading 504, velocity 506, acceleration 508, turn signal 510, longitudinal position 512, lateral position 514, velocity 516, acceleration 518, environment conditions 520) can complete a forward pass through one or more hidden layers of the deep learning neural network 802. In various cases, an output layer of the deep learning neural network 802 can compute the risk level 804, based on activation maps or intermediate features produced by the one or more hidden layers.

In various aspects, the risk level 804 can be any suitable electronic data exhibiting any suitable format, size, or dimensionality. That is, the risk level 804 can be one or more scalars, one or more vectors, one or more matrices, one or more tensors, one or more character strings, or any suitable combination thereof. In various instances, the risk level 804 can indicate, specify, convey, or otherwise represent a risk level associated with the overtaking by vehicle 106 of vehicle 102.

As a non-limiting example, the risk level 804 can be a multinomial variable that can take on one more possible discrete states. In such case, one of the two possible discrete states can represent a “risky” state, whereas the other of the two possible discrete states can represent an “no-risk” state. That is, the risk level 804 can take on the “risky” state when the deep learning neural network 802 infers that the overtaking by vehicle 106 of vehicle 102 is risky, and the risk level 804 can take on the “no-risk” state when the deep learning neural network 802 instead infers that overtaking by vehicle 106 of vehicle 102 is not risky. As another non-limiting example, the risk level 804 can be a scalar whose magnitude (e.g., ranging continuously from 0 to 1) represents a likelihood or probability that overtaking by vehicle 106 of vehicle 102 is risky (or that overtaking by vehicle 106 of vehicle 102 is not risky). As another non-limiting example, the risk level 804 can be a multinomial variable that can take on one or more possible discrete states. For instance, the risk level 804 can have a “no-risk” state, an “low-risk” state, a “high-risk” state, or a “very-high-risk” state.

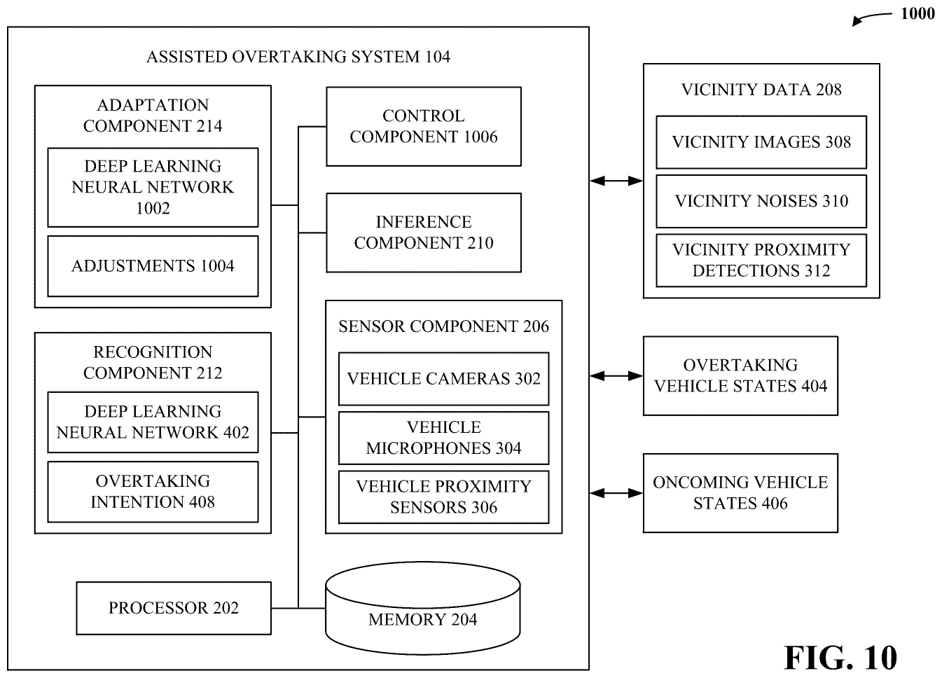

FIG. 10 illustrates a block diagram of an example, non-limiting system 1000 including a deep learning neural network, adjustments, and a control component that can facilitate artificially intelligent assistance of hazardous overtaking initiatives in accordance with one or more embodiments described herein. As shown, the system 1000 can, in some cases, comprise the same components as the system 800, and can further comprise deep learning neural network 1002, adjustments 1004, or control component 1006.

In various embodiments, the adaptation component 214 can receive risk level 804 from inference component 210. In various aspects, the adaptation component 214 can refrain from determining adjustments 1004 based on the risk level 804. That is, if the risk level 804 indicates that there is no risk (e.g., there are no oncoming vehicles), the adaptation component 214 can refrain from determining adjustments 1004. Conversely, if the risk level 804 indicates that there is risk (e.g., possible collision between vehicle 106 and oncoming vehicle 108), the adaptation component 214 can proceed with determining adjustments 1004. Alternatively, in some cases, the inference component 210 can refrain from engaging the adaptation component 214 to determine adjustments 1004 based on the risk level 804 indicating there is no risk.

In various embodiments, the adaptation component 214 can electronically store, electronically maintain, electronically control, or otherwise electronically access the deep learning neural network 1002. In various aspects, the deep learning neural network 1002 can have or otherwise exhibit any suitable internal architecture. For instance, the deep learning neural network 1002 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be convolutional layers, whose learnable or trainable parameters can be convolutional kernels. As another example, any of such input layer, one or more hidden layers, or output layer can be dense layers, whose learnable or trainable parameters can be weight matrices or bias values. As still another example, any of such input layer, one or more hidden layers, or output layer can be batch normalization layers, whose learnable or trainable parameters can be shift factors or scale factors. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers.

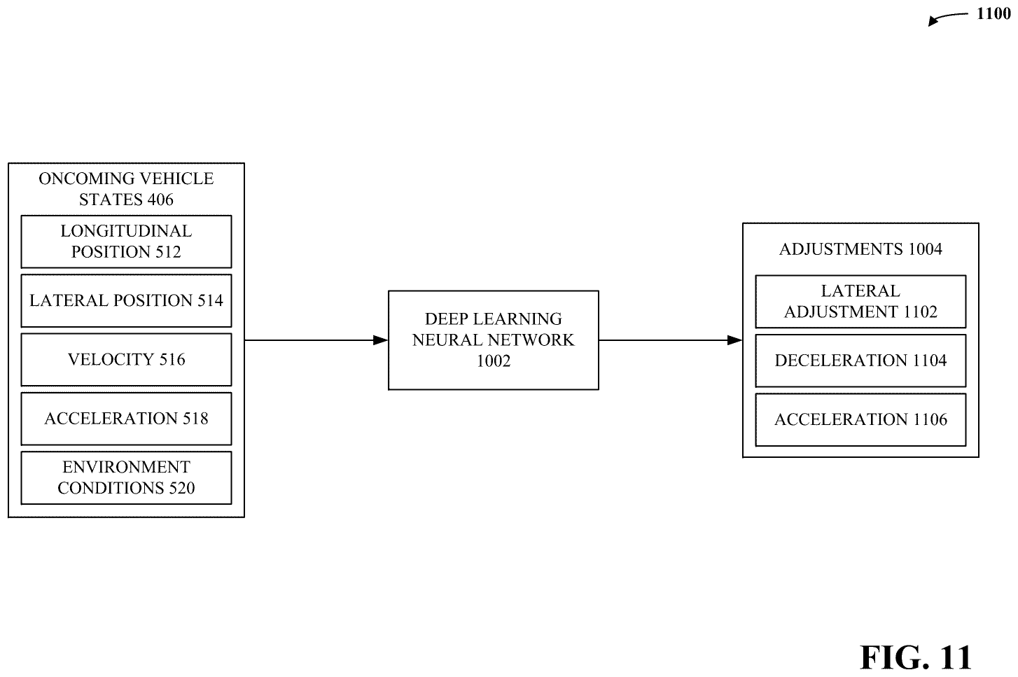

No matter the internal architecture of the deep learning neural network 1002, the deep learning neural network 1002 can be configured to determine adjustments of the current trajectory of vehicle 102. That is, the deep learning neural network 1002 can be configured to determine adjustments 1004 of the current trajectory of vehicle 102 that facilitate completion of overtaking by vehicle 106 or deter overtaking by vehicle 106 based on oncoming vehicle states 406. Various non-limiting aspects are described with respect to FIG. 11. Accordingly, the adaptation component 214 can electronically execute the deep learning neural network 1002 on the oncoming vehicle states 406, thereby yielding the adjustments 1004. In response to a determination of adjustments 1004, the adaptation component 214 can engage the control component 1006 to execute adjustments 1004. In particular, the control component 1006 can generate one or more acceleration requests to adjust the current trajectory of vehicle 102 in accordance with the adjustments 1004 of the current trajectory of vehicle 102. In various embodiments, the control component 1006 can electronically control or otherwise electronically access any suitable hardware and/or software of vehicle 102 to generate the one or more acceleration requests and thus execute adjustments 1004. For instance, the control component 1006 can electronically interact with or access an ADS of vehicle 102 to execute adjustments 1004 (e.g., electronically transmit requests to a decision control module of the ADS for arbitration and actuation). In this way, the vehicle 102 can be considered as safely facilitating completion of overtaking by vehicle 106 or deterring overtaking by vehicle 106 by leveraging an ADS of vehicle 102 (e.g., leveraging capabilities of AVs).

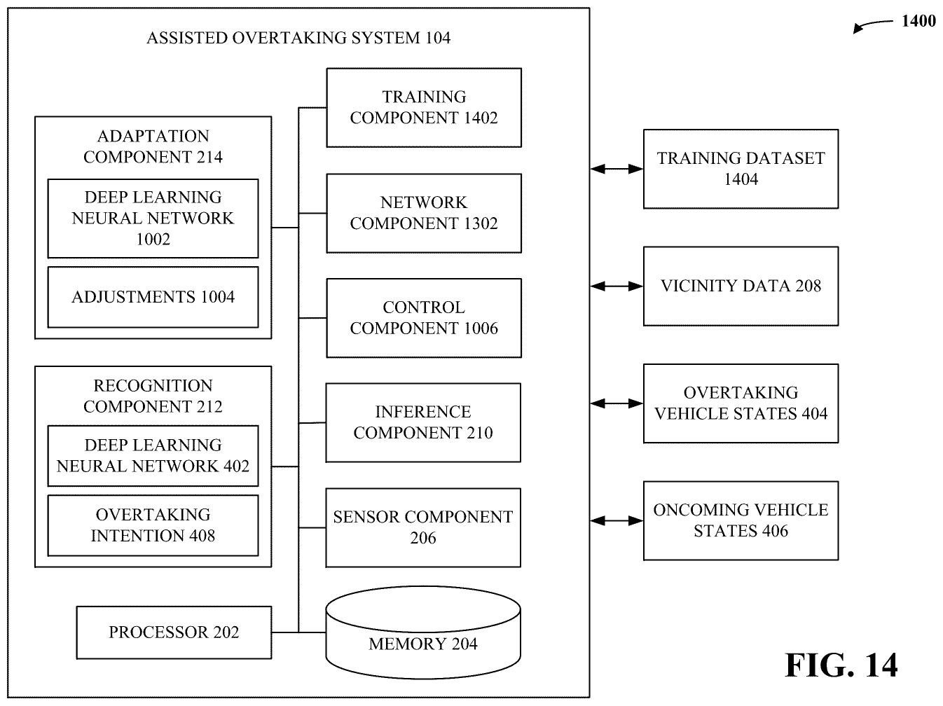

To help ensure that the adjustments 1004 are accurate (e.g., safe to facilitate completion or deterrence of overtaking by vehicle 106 of vehicle 102), the deep learning neural network 1002 can first undergo training. Various non-limiting aspects of such training are described with respect to FIGS. 14-16.

FIG. 11 illustrates an example, non-limiting block diagram 1100 showing how the deep learning neural network 1002 can generate adjustments 1004 based on the oncoming vehicle states 406 and in accordance with one or more embodiments described herein.

As shown, the adaptation component 214 can, in various aspects, execute the deep learning neural network 1002 on the oncoming vehicle states 406, and such execution can cause the deep learning neural network 1002 to produce the adjustments 1004. More specifically, the adaptation component 214 can feed the oncoming vehicle states 406 (e.g., longitudinal position 512, lateral position 514, velocity 516, acceleration 518, environment conditions 520) to an input layer of the deep learning neural network 1002. In various instances, the oncoming vehicle states 406 (e.g., longitudinal position 512, lateral position 514, velocity 516, acceleration 518, environment conditions 520) can complete a forward pass through one or more hidden layers of the deep learning neural network 1002. In various cases, an output layer of the deep learning neural network 1002 can compute the adjustments 1004, based on activation maps or intermediate features produced by the one or more hidden layers.

In various aspects, the adjustments 1004 can be any suitable electronic data exhibiting any suitable format, size, or dimensionality. That is, the adjustments 1004 can be one or more scalars, one or more vectors, one or more matrices, one or more tensors, one or more character strings, or any suitable combination thereof. In various instances, the adjustments 1004 can indicate, specify, convey, or otherwise represent various adjustments in connection with operation of vehicle 102 to facilitate completion of overtaking by vehicle 106 of vehicle 102 or deter overtaking by vehicle 106 of vehicle 102. In some cases, if overtaking intention 408 indicates that vehicle 106 is attempting to overtake vehicle 102, then the adjustments 1004 can further indicate, specify, convey, or otherwise represent any suitable characteristics, attributes, or properties of such adjustments to the current trajectory of vehicle 102.

In various instances, the adjustments 1004 can be generated by executing the deep learning neural network 1002 on the overtaking vehicle states 404. In other instances, the deep learning neural network 1002 can be executed on the overtaking vehicle states 406 and the oncoming vehicle states 406 to generate the adjustments 1004.

In various aspects, as shown, the adjustments 1004 can comprise lateral adjustment 1102. In various instances, the lateral adjustment 1102 can have any suitable format, size, or dimensionality. That is, the lateral adjustment 1102 can be one or more scalars, one or more vectors, one or more matrices, one or more tensors, one or more character strings, or any suitable combination thereof. In any case, the lateral adjustment 1102 can indicate, convey, or otherwise represent any suitable lateral distance that vehicle 102 should travel to facilitate completion of overtaking by vehicle 106 or deter overtaking by vehicle 106. For instance, the deep learning neural network 1002 can be trained or otherwise configured, as described herein, to determine, based on the oncoming vehicle states 406, the lateral adjustment 1102 of vehicle 102. In any case, the lateral adjustment 1102 can represent the determination, inference, or conclusion generated by the deep learning neural network 1002 with respect to lateral adjustment 1102 of vehicle 102 to facilitate completion of overtaking by vehicle 106 or deter overtaking by vehicle 106.

As a non-limiting example, the lateral adjustment 1102 can be a variable that can take on one or more possible continuous values. In such case, the one or more possible continuous values can respectively represent any suitable lateral distance for vehicle 102 to adjust to. For instance, the lateral adjustment 1102 can represent coordinates (e.g., such as latitude) or a lateral distance for vehicle 102 to travel. As another non-limiting example, the lateral adjustment 1102 can be a scalar whose magnitude represents the lateral distance for vehicle 102 to travel.

In various aspects, as shown, the adjustments 1004 can comprise deceleration 1104. In various instances, the deceleration 1104 can have any suitable format, size, or dimensionality. That is, the deceleration 1104 can be one or more scalars, one or more vectors, one or more matrices, one or more tensors, one or more character strings, or any suitable combination thereof. In any case, the deceleration 1104 can indicate, convey, or otherwise represent the adjustment in acceleration of vehicle 102 to facilitate completion of overtaking by vehicle 106 or deter overtaking by vehicle 106. For instance, the deep learning neural network 1002 can be trained or otherwise configured, as described herein, to determine, based on the oncoming vehicle states 406, the deceleration 1104 of vehicle 102. In any case, the deceleration 1104 can represent the determination, inference, or conclusion generated by the deep learning neural network 1002 with respect to adjustment of acceleration 110 of vehicle 102 to facilitate completion of overtaking by vehicle 106 or deter overtaking by vehicle 106.

As a non-limiting example, the deceleration 1104 can be a variable that can take on one or more possible continuous values. In such case, the one or more possible continuous values can respectively represent any suitable acceleration of vehicle 102. For instance, the deceleration 1104 can be a scalar whose magnitude represents the acceleration of vehicle 102.

In various aspects, as shown, the adjustments 1004 can comprise acceleration 1106. In various instances, the acceleration 1106 can have any suitable format, size, or dimensionality. That is, the acceleration 1106 can be one or more scalars, one or more vectors, one or more matrices, one or more tensors, one or more character strings, or any suitable combination thereof. In any case, the acceleration 1106 can indicate, convey, or otherwise represent the adjustment in acceleration of vehicle 102 to facilitate completion of overtaking by vehicle 106 or deter overtaking by vehicle 106. For instance, the deep learning neural network 1002 can be trained or otherwise configured, as described herein, to determine, based on the oncoming vehicle states 406, the acceleration 1106 of vehicle 102. In any case, the acceleration 1106 can represent the determination, inference, or conclusion generated by the deep learning neural network 1002 with respect to adjustment of acceleration 110 of vehicle 102 to facilitate completion of overtaking by vehicle 106 or deter overtaking by vehicle 106.

As a non-limiting example, the acceleration 1106 can be a variable that can take on one or more possible continuous values. In such case, the one or more possible continuous values can respectively represent any suitable acceleration of vehicle 102. For instance, the acceleration 1106 can be a scalar whose magnitude represents the acceleration of vehicle 102.

As a non-limiting example, in response to the recognition component 212 detecting vehicle 106 and determining overtaking intention 408 indicates that vehicle 106 is attempting to overtake vehicle 102 (e.g., has turn signal activated, has approached the side of vehicle 102, has accelerated), the control component 1006 can cause (e.g., based on adjustments 1004 determined by adaptation component 214) vehicle 102 to move laterally to provide the driver of vehicle 106 with better visibility to detect and estimate the risk for oncoming traffic. For example, if there is traffic jam ahead (e.g., a truck obstructing visibility of the vehicles behind), moving laterally can help vehicle 106 see the traffic jam and decide to cancel the overtaking.

As another non-limiting example, during the course of overtaking by vehicle 106 of vehicle 102, where vehicle 106 is driving in the adjacent lane passing a certain relative position to vehicle 102, the control component 1006 can cause (e.g., based on adjustments 1004 determined by adaptation component 214) vehicle 102 to lower its longitudinal speed (e.g., decelerate) or slightly move laterally to help vehicle 106 complete the overtaking earlier by merging into the lane of vehicle 102. Thus, risks of getting collisions with oncoming traffic (which may accelerate suddenly during the overtaking) can be mitigated.

As yet another non-limiting example, a driver of vehicle 106 can be driving recklessly and initiate overtaking of vehicle 102. The driver of vehicle 106 can then realize a collision with oncoming traffic will happen without performing harsh braking. In such cases, the control component 1006 can cause (e.g., based on adjustments 1004 determined by adaptation component 214) vehicle 102 to accelerate longitudinally and optionally move laterally towards to the lane marker to deter the driver of vehicle 102 from proceeding with the overtaking of vehicle 102.

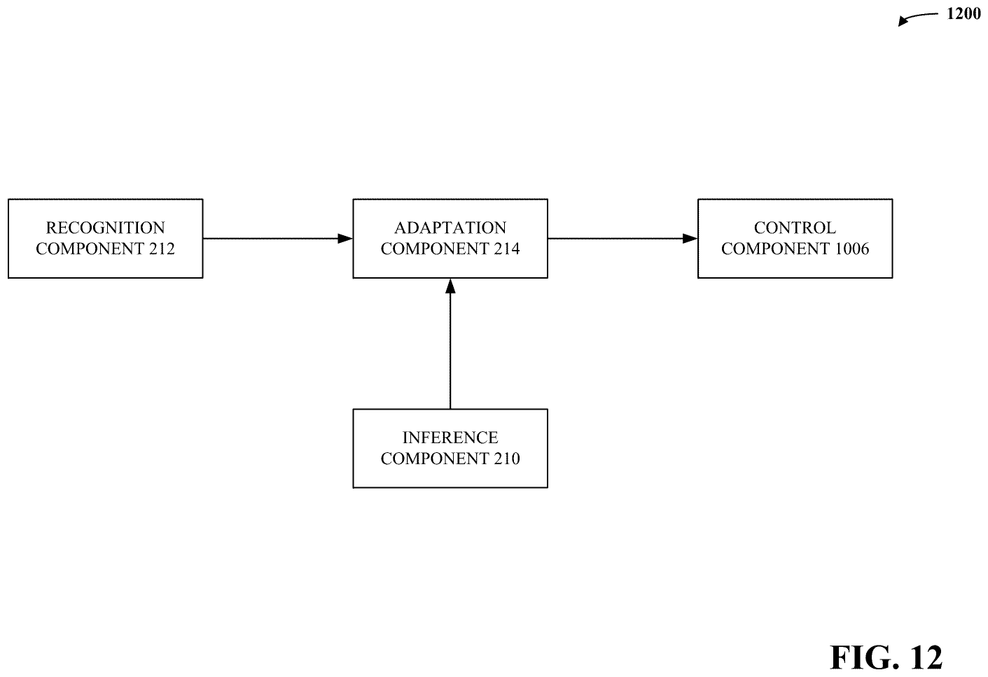

FIG. 12 illustrates a block diagram of an example, non-limiting system 1200 that can facilitate artificially intelligent assistance of hazardous overtaking initiatives in accordance with one or more embodiments described herein. Repetitive description of like elements is omitted for sake of brevity.

As explained above, the recognition component 212 can generate overtaking vehicle states 404 or oncoming vehicle states 406 based on vicinity data 208. In various embodiments, the recognition component 212 can estimate overtaking vehicle states 404 or oncoming vehicle states 406 over any suitable duration of time. That is, the recognition component 212 can track the vehicle 106 for the duration of overtaking by vehicle 106 (e.g., until completion of overtaking, until deterrence of overtaking). Specifically, the recognition component 212 can estimate one or more overtaking vehicle states 404 or one or more oncoming vehicle states 406 over the duration of time based on continuous monitoring of the vicinity via sensor component 206.

Further, the recognition component 212 can determine if there is overtaking intention by vehicle 106 of vehicle 102. In various cases, the recognition component 212 can also determine a type of overtaking by vehicle 106 (e.g., unform overtaking, accelerated overtaking) based on the overtaking vehicle states 404. In any case, in response to a determination that there is overtaking intention by vehicle 106, the inference component 210 can infer risk level 804 of the oncoming vehicle 108 based on the overtaking vehicle states 404 or oncoming vehicle states 406. In various embodiments, the adaptation component 214 can receive or otherwise electronically access the overtaking vehicle states 404, the oncoming vehicle states 406, and/or the risk level 804. Thus, the adaptation component 214 can respectively generate the adjustments 1004, in response to the risk level 804 indicating that there is risk associated with overtaking of vehicle 102 by vehicle 106. In contrast, the adaptation component 214 can respectively refrain from generating the adjustments 1004, in response to the risk level 804 indicating that there is no risk associated with overtaking of vehicle 102 by vehicle 106. Indeed, in such case, the vicinity data 208 can be deleted or discarded, the sensor component 206 can capture new vicinity data (e.g., a new instance of 208), and the inference component 210, the recognition component 212, and the adaptation component 214 can perform their respective functionalities with respect to the new vicinity data. Accordingly, the assisted overtaking system 104 can be considered as repeatedly recording and discarding vicinity data, until overtaking intention by vehicle 106 is detected. Upon such detection, the overtaking vehicle states 404 and/or oncoming vehicle states 406 can be generated and the most recently captured vicinity data can be preserved, stored, or otherwise maintained for use.

In any case, in response to determination of adjustments 1004, the control component 1006 can receive or otherwise electronically access the adjustments 1004. Accordingly, the control component 1006 can generate one or more acceleration requests to execute adjustments 1004 on the current trajectory of vehicle 102.

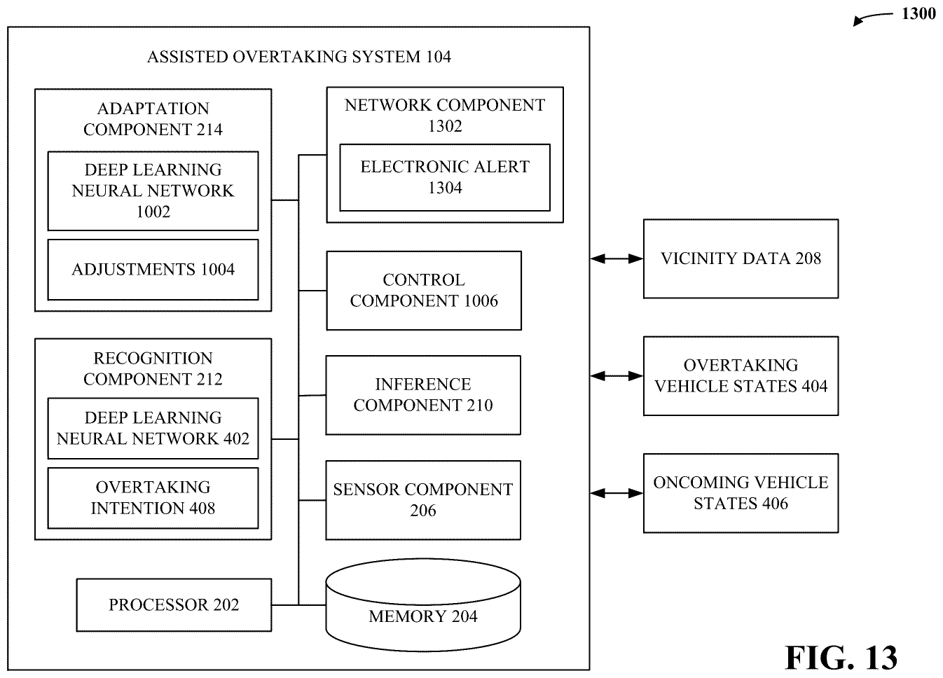

FIG. 13 illustrates a block diagram of an example, non-limiting system 1300 including a network component and an electronic alert that can facilitate artificially intelligent assistance of hazardous overtaking initiatives in accordance with one or more embodiments described herein. As shown, the system 1300 can, in some cases, comprise the same components as the system 1000, and can further comprise network component 1302 or electronic alert 1304.

In various embodiments, the network component 1302 can communicate, via Vehicle-to-Vehicle (V2V) communication (e.g., or any suitable communication link), with the oncoming vehicle 108 to request deceleration of the oncoming vehicle 108. That is, the network component 1302 can electronically transmit an electronic alert 1304 to oncoming vehicle 108.

In various embodiments, the electronic alert 1304 can comprise any suitable electronic data pertaining to the overtaking of vehicle 102 by vehicle 106 detected by the deep learning neural network 402, deep learning neural network 802, or deep learning neural network 1002. As a non-limiting example, the electronic alert 1304 can comprise the overtaking vehicle states 404. That is, the electronic alert 1304 can include any data outputted by deep learning neural network 402.

As yet another non-limiting example, the electronic alert 1304 can comprise the vicinity data 208 (or any suitable portion thereof). That is, the electronic alert 1304 can contain whatever raw data was recorded, measured, or otherwise captured by the sensor component 206 and on the basis of which the deep learning neural network 402 detected overtaking intention 408 (e.g., the electronic alert 1304 can contain the set of vicinity images 308, the set of vicinity noises 310, or the set of vicinity proximity detections 312).

Although not explicitly shown in the figures, the electronic alert 1304 can be written or otherwise organized according to any suitable protocol or syntax (e.g., can have any suitable header, can have any suitable body).

In any case, the network component 1302 can generate the electronic alert 1304, and the network component 1302 can transmit the electronic alert 1304 to vehicle 108 via V2V communication.

In various embodiments, the assisted overtaking system 104 can receive information or data associated with oncoming vehicle 108 via V2V connection. For instance, the recognition component 212 can receive such data to generate more accurate estimates of oncoming vehicle states 406.

FIG. 14 illustrates a block diagram of an example, non-limiting system 1400 including a training component and a training dataset that can facilitate artificially intelligent assistance of hazardous overtaking initiatives in accordance with one or more embodiments described herein. As shown, the system 1400 can, in some cases, comprise the same components as the system 1300, and can further comprise a training component 1402 or a training dataset 1404.

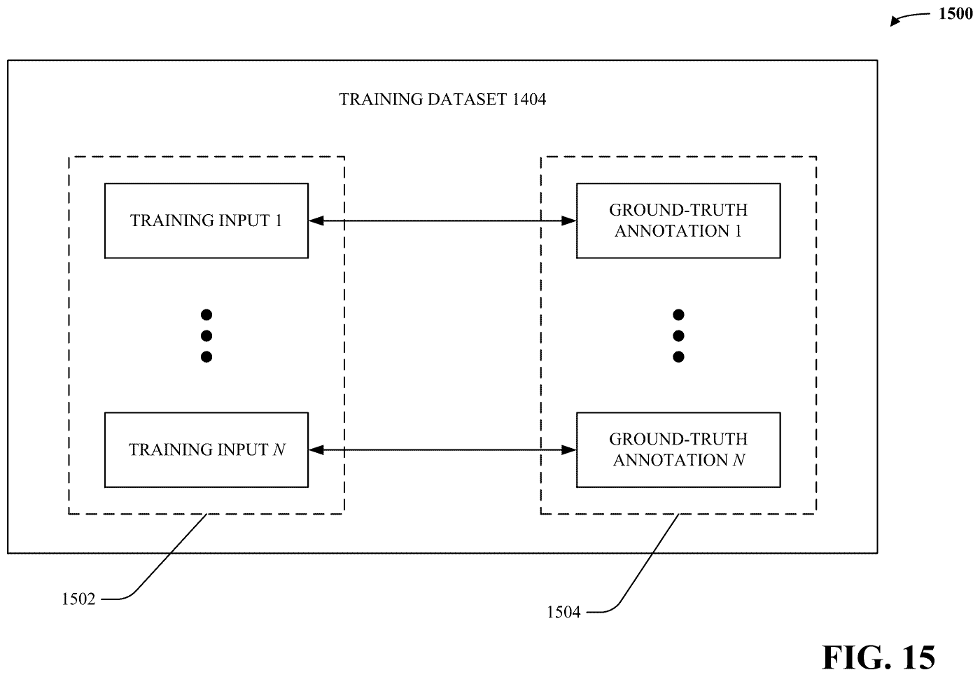

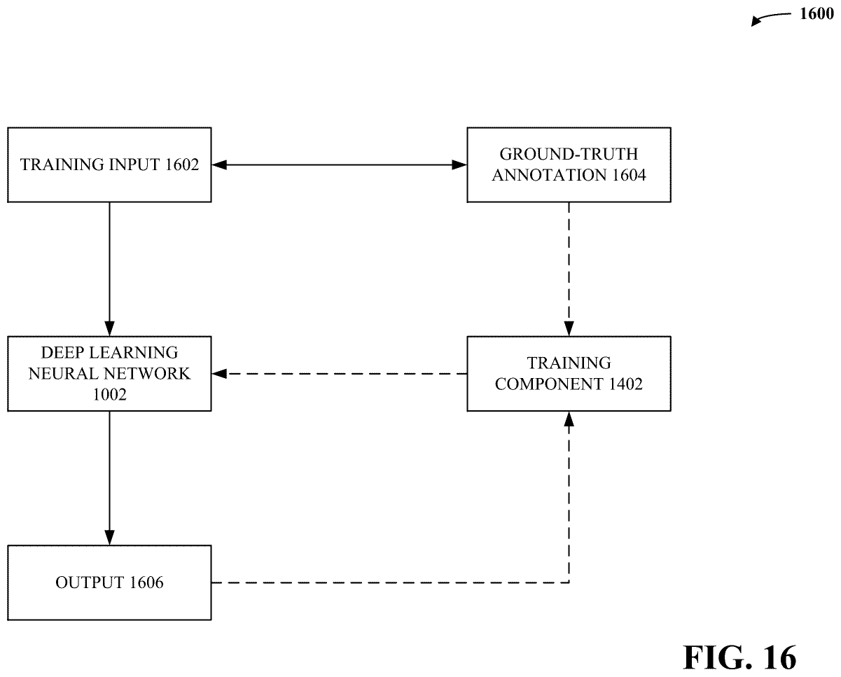

In various aspects, the training component 1402 can electronically receive, retrieve, obtain, or otherwise access, from any suitable source, the training dataset 1404. In various aspects, the training component 1402 can train the deep learning neural network 1002 based on the training dataset 1404. Various non-limiting aspects are described with respect to FIGS. 15-16.

FIG. 15 illustrates an example, non-limiting block diagram 1500 of the training dataset 1404 in accordance with one or more embodiments described herein. As shown, the training dataset 1404 can, in various aspects, comprise a set of training inputs 1502 and a set of ground-truth annotations 1504.

In various aspects, the set of training inputs 1502 can include n inputs for any suitable positive integer n: a training input 1 to a training input n. In various instances, a training input can be any suitable electronic data having the same format, size, or dimensionality as the oncoming vehicle states 406. In other words, each training input can be data describing oncoming vehicles that is determined based on vicinity data associated with a vicinity of a vehicle that is captured by sensors of the vehicle. For example, the training input 1 can include a first set of training longitudinal positions of a first oncoming vehicle, a first set of training lateral positions of a first oncoming vehicle, a first set of training velocities of a first oncoming vehicle, a first set of training accelerations of a first oncoming vehicle, a first set of training environment condition detections of a first vehicle vicinity, or a first set of training risk levels of the first oncoming vehicle. Likewise, as another example, the training input n can include an n-th set of training longitudinal positions of an n-th oncoming vehicle, an n-th set of training lateral positions of the n-th oncoming vehicle, an n-th set of training velocities of an n-th oncoming vehicle, an n-th set of training accelerations of the n-th oncoming vehicle, an n-th set of training environment condition detections of an n-th vehicle vicinity, or an n-th set of training risk levels of the n-th oncoming vehicle.

In various aspects, the set of ground-truth annotations 1504 can respectively correspond (e.g., in one-to-one fashion) to the set of training inputs 1502. Thus, since the set of training inputs 1502 can have n inputs, the set of ground-truth annotations 1504 can have n annotations: a ground-truth annotation 1 to a ground-truth annotation n. In various instances, each of the set of ground-truth annotations 1504 can have the same format, size, or dimensionality as the adjustments 1004. That is, each ground-truth annotation can be any suitable electronic data that indicates or represents an adjustment (e.g., lateral adjustment, deceleration, acceleration) to the current trajectory of the vehicle that is known or deemed to be manifested in a respective training input. For example, the ground-truth annotation 1 can correspond to the training input 1. Accordingly, the ground-truth annotation 1 can be considered as the correct or accurate adjustment that will facilitate completion or deterrence of overtaking by a second vehicle. As another example, the ground-truth annotation n can correspond to the training input n. Accordingly, the ground-truth annotation n can be considered as the correct or accurate adjustment that will facilitate completion or deterrence of overtaking by the second vehicle.

Now, consider FIG. 16. FIG. 16 illustrates an example, non-limiting block diagram 1600 showing how the deep learning neural network 1002 can be trained in accordance with one or more embodiments described herein.

In various aspects, the training component 1402 can, prior to beginning training, initialize in any suitable fashion (e.g., random initialization) the trainable internal parameters (e.g., convolutional kernels, weight matrices, bias values) of the deep learning neural network 1002.

In various aspects, the training component 1402 can select, from the training dataset 1404, a training input 1602 and a ground-truth annotation 1604 corresponding to the training input 1602. In various instances, the training component 1402 can execute the deep learning neural network 1002 on the training input 1602, thereby causing the deep learning neural network 1002 to produce an output 1606. More specifically, in some cases, an input layer of the deep learning neural network 1002 can receive the training input 1602, the training input 1602 can complete a forward pass through one or more hidden layers of the deep learning neural network 1002, and an output layer of the deep learning neural network 1002 can compute the output 1606 based on activation maps or intermediate features provided by the one or more hidden layers.

In various aspects, the output 1606 can be considered as the predicted or inferred adjustments (e.g., as the lateral adjustment, the deceleration, the acceleration) that the deep learning neural network 1002 believes should correspond to the training input 1602. In contrast, the ground-truth annotation 1604 can be considered as the correct/accurate vehicular collision classification label (e.g., as the correct/accurate lateral adjustment, the correct/accurate deceleration, the correct/accurate acceleration) that is known or deemed to correspond to the training input 1602. Note that, if the deep learning neural network 1002 has so far undergone no or little training, then the output 1606 can be highly inaccurate. In other words, the output 1606 can be very different from the ground-truth annotation 1604.

In various aspects, the training component 1402 can compute one or more errors or losses (e.g., MAE, MSE, cross-entropy) between the output 1606 and the ground-truth annotation 1604. In various instances, the training component 1402 can incrementally update, via backpropagation, the trainable internal parameters of the deep learning neural network 1002, based on such one or more errors or losses.

In various cases, the training component 1402 can repeat such execution-and-update procedure for each training input in the training dataset 1404. This can ultimately cause the trainable internal parameters of the deep learning neural network 1002 to become iteratively optimized for accurately determining adjustments that will facilitate completion or deterrence of overtaking by the second vehicle of the first vehicle. In various aspects, the training component 1402 can implement any suitable training batch sizes, any suitable error/loss functions, or any suitable training termination criteria.

In various embodiments, the training component 1402 can train the deep learning neural network 402 or the deep learning neural network 802 in a similar fashion as the deep learning neural network 1002. That is, the deep learning neural network 402 or the deep learning neural network 802 can comprise a same or similar architecture as the deep learning neural network 1102.

Further, the training component 1402 can, prior to beginning training, initialize in any suitable fashion (e.g., random initialization) the trainable internal parameters (e.g., convolutional kernels, weight matrices, bias values) of the deep learning neural network 402 or the deep learning neural network 802.

In various embodiments, the training datasets 1404 for training the deep learning neural network 402 can include training input 1502 that describes the vicinity data 208 (e.g., a set of vicinity images, a set of vicinity noises, a set of vicinity proximity sensors) and ground-truth annotation 1504 that describes states of vehicle 106 (e.g., 404) and/or states of vehicle 108 (e.g., 406). The ground-truth annotation 1504 can be considered as the correct or accurate states of vehicle 106 or vehicle 108 based on vicinity data 208. In various instances, the training datasets 1404 for training the deep learning neural network 402 can further ground-truth annotation 1504 that describes an overtaking intention of vehicle 106 (e.g., 408). Such ground-truth annotation 1504 can be considered as the correct or accurate determination of overtaking intention by vehicle 106 of vehicle 102.

In various embodiments, the training datasets 1404 for training the deep learning neural network 802 can include training input 1502 that describes the states of vehicle 106 (e.g., 404) and/or states of vehicle 108 (e.g., 406), and ground-truth annotation 1504 that describes a risk level (e.g., 804) associated with overtaking by vehicle 106 based on states of vehicle 108. The ground-truth annotation 1504 can be considered as the correct or accurate risk level associated with overtaking by vehicle 106.

In such instances, the training component 1402 can repeat such execution-and-update procedure for each training input in the training dataset 1404 for the deep learning neural network 402 or the deep learning neural network 802 respectively. This can ultimately cause the trainable internal parameters of the deep learning neural network 402 to become iteratively optimized for accurately determining the overtaking intention of vehicle 106 or estimating states of vehicle 106 or vehicle 108. This can further ultimately cause the trainable internal parameters of the deep learning neural network 802 to become iteratively optimized for accurately determining the risk level 804 associated with overtaking by vehicle 106. In various aspects, the training component 1402 can implement any suitable training batch sizes, any suitable error/loss functions, or any suitable training termination criteria.

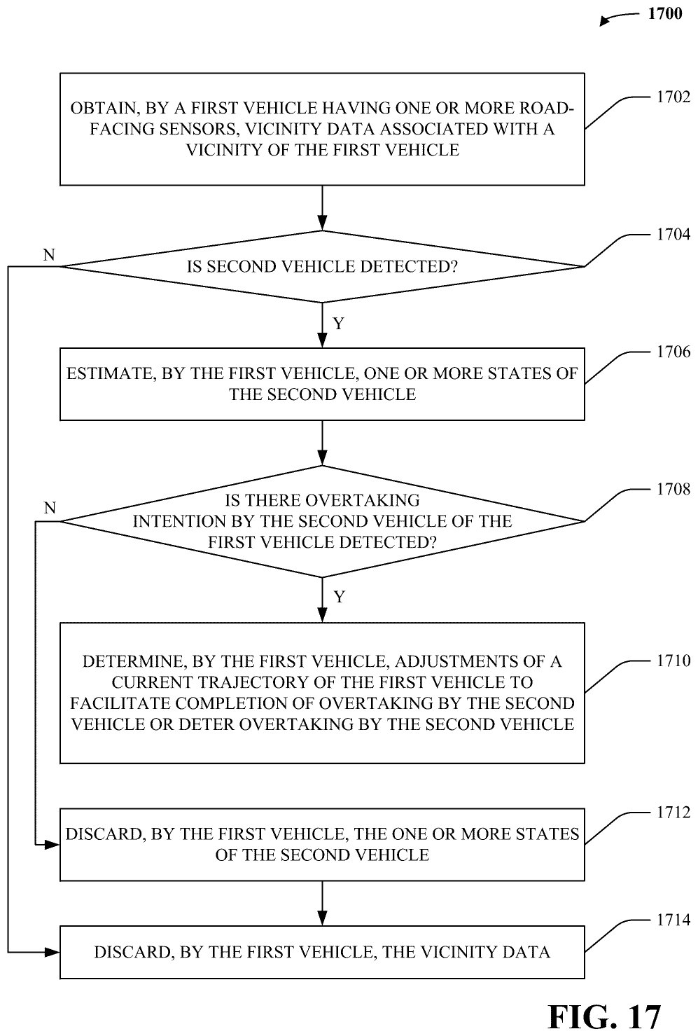

FIG. 17 illustrates a flow diagram of an example, non-limiting computer-implemented method 1700 that can facilitate artificially intelligent assistance of hazardous overtaking initiatives in accordance with one or more embodiments described herein. In various cases, the assisted overtaking system 104 can facilitate the computer-implemented method 1700.

In various embodiments, act 1702 can include obtaining, by a first vehicle (e.g., 102) having one or more road-facing sensors (e.g., 206) vicinity data (e.g., 208) associated with a vicinity of the first vehicle. In some cases, the one or more road-facing sensors can include cameras (e.g., 302), microphones (e.g., 304), or proximity detectors (e.g., 306).

In various aspects, act 1704 can include determining, by the first vehicle (e.g., via 212), whether a second vehicle (e.g. 104) is detected. If not (e.g., if a second vehicle is not detected), the computer-implemented method 1700 can proceed to act 1714. If so (e.g., if a second vehicle is detected), the computer-implemented method 1700 can proceed to act 1706.

In various instances, act 1706 can include estimating, by the first vehicle (e.g., 212), one or more states (e.g., 404) of a second vehicle (e.g., 106).

In various aspects, act 1708 can include determining, by the first vehicle (e.g., via 212), whether there is overtaking intention by the second vehicle of the first vehicle. If not (e.g., if there is no overtaking intention by the second vehicle of the first vehicle), the computer-implemented method 1700 can proceed to act 1712. If so (e.g., if there is overtaking intention by the second vehicle of the first vehicle), the computer-implemented method 1700 can proceed to act 1710.

In various instances, act 1710 can include determining, by the first vehicle (e.g., via 214), adjustments (e.g., 1004) of a current trajectory of the first vehicle to facilitate completion of overtaking by the second vehicle of deter overtaking by the second vehicle.

In various cases, act 1712 can include discarding, by the first vehicle (e.g., via 212) the one or more states of the second vehicle.

In various aspects, act 1714 can include discarding, by the first vehicle (e.g., via 212) the vicinity data. In various cases, the computer-implemented method 1700 can proceed back to act 1702.

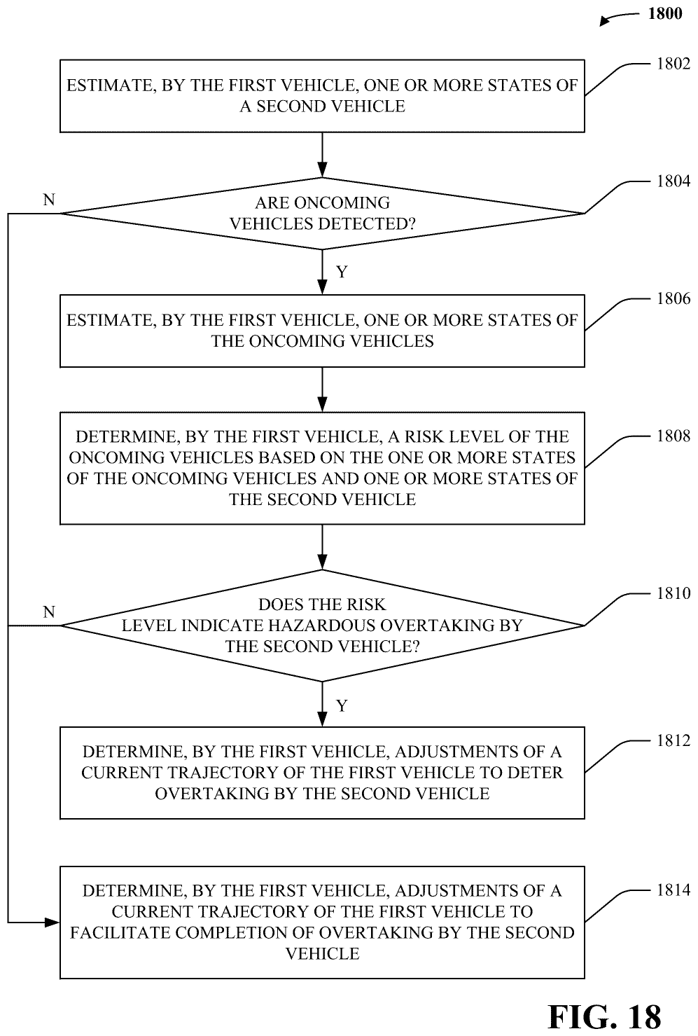

FIG. 18 illustrates a flow diagram of an example, non-limiting computer-implemented method 1800 that can facilitate artificially intelligent assistance of hazardous overtaking initiatives in accordance with one or more embodiments described herein. In various cases, the assisted overtaking system 104 can facilitate the computer-implemented method 1800.

In various embodiments, act 1802 can include estimating, by the first vehicle (e.g., 212), one or more states (e.g., 404) of a second vehicle (e.g., 106).

In various aspects, act 1804 can include determining, by the first vehicle (e.g., via 212), whether one or more oncoming vehicles (e.g. 108) are detected. If not (e.g., if one or more oncoming vehicles are not detected), the computer-implemented method 1800 can proceed to act 1814. If so (e.g., if one or more oncoming vehicles are detected), the computer-implemented method 1800 can proceed to act 1806.

In various instances, act 1806 can include estimating, by the first vehicle (e.g., 212), one or more states of the oncoming vehicles (e.g., 406).

In various aspects, act 1808 can include determining, by the first vehicle (e.g., via 210), a risk level (e.g., 804) of the oncoming vehicles based on the one or more states of the oncoming vehicles and the one or more states of the second vehicle.

In various instances, act 1810 can include determining, by the first vehicle (e.g., via 210), whether the risk level indicates hazardous overtaking by the second vehicle. If not (e.g., if the risk level does not indicate hazardous overtaking by the second vehicle), the computer-implemented method 1800 can proceed to act 1814. If so (e.g., if the risk level indicates hazardous overtaking by the second vehicle), the computer-implemented method 1800 can proceed to act 1812.

In various cases, act 1812 can include determining, by the first vehicle (e.g., via 214), adjustments (e.g., 1004) of a current trajectory of the first vehicle to deter overtaking by the second vehicle.

In various aspects, act 1814 can include determining, by the first vehicle (e.g., via 214), adjustments of the current trajectory of the first vehicle to facilitate completion of overtaking by the second vehicle.

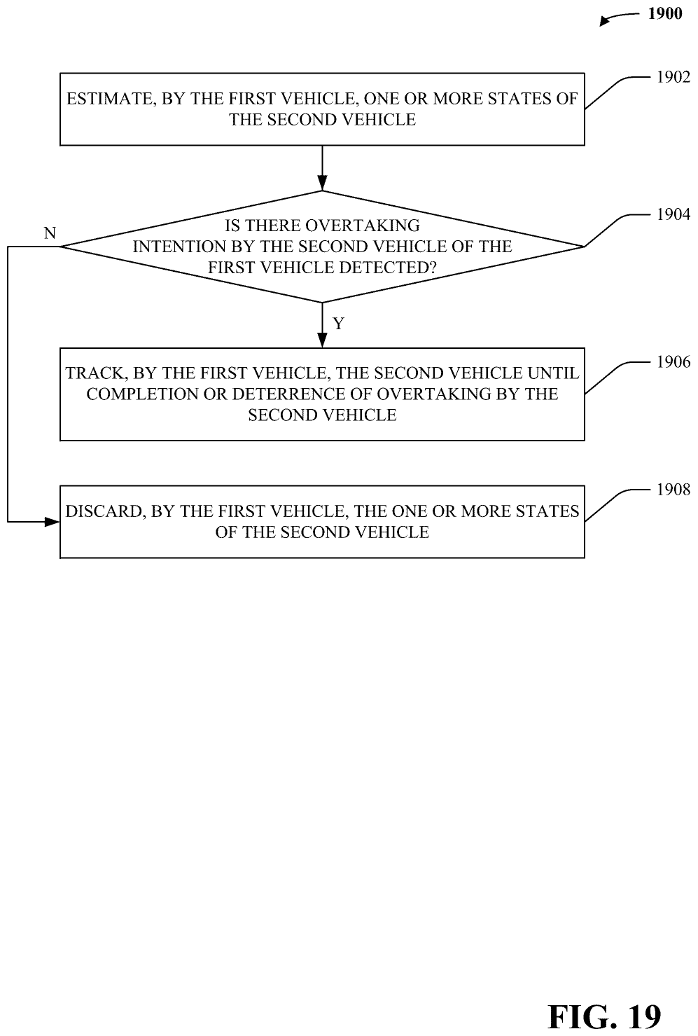

FIG. 19 illustrates a flow diagram of an example, non-limiting computer-implemented method 1900 that can facilitate artificially intelligent assistance of hazardous overtaking initiatives in accordance with one or more embodiments described herein. In various cases, the assisted overtaking system 104 can facilitate the computer-implemented method 1900.

In various embodiments, act 1902 can include estimating, by the first vehicle (e.g., 212), one or more states (e.g., 404) of a second vehicle (e.g., 106).

In various aspects, act 1904 can include determining, by the first vehicle (e.g., via 212), whether there is overtaking intention by the second vehicle of the first vehicle. If not (e.g., if there is no overtaking intention by the second vehicle of the first vehicle), the computer-implemented method 1900 can proceed to act 1908. If so (e.g., if there is overtaking intention by the second vehicle of the first vehicle), the computer-implemented method 1900 can proceed to act 1906.

In various instances, act 1906 can include tracking, by the first vehicle (e.g., 212), the second vehicle until completion or deterrence of overtaking by the second vehicle.

In various aspects, act 1908 can include discarding, by the first vehicle (e.g., via 212), the one or more states of a second vehicle.

Although the herein disclosure mainly describes various embodiments as implementing deep learning neural networks (e.g., 606, 802, 1002), this is a mere non-limiting example. In various aspects, the herein-described teachings can be implemented via any suitable machine learning models exhibiting any suitable artificial intelligence architectures (e.g., support vector machines, naïve Bayes, linear regression, logistic regression, decision trees, random forest).

Although the herein disclosure mainly describes various embodiments as determining adjustments to the current trajectory of a vehicle in response to detecting overtaking intention by a second vehicle of the first vehicle, this is a mere non-limiting example. In various aspects, the herein-described teachings can be extrapolated to determining adjustments to the current trajectory of a vehicle in response to detecting any hazardous actions taken by the second vehicle (e.g., speeding by the second vehicle, swerving by the second vehicle).

Although the herein disclosure mainly describes various embodiments as determining adjustments to the current trajectory of a vehicle in response to detecting overtaking intention by a second vehicle of the first vehicle and detecting oncoming vehicles, this is a mere non-limiting example. In various aspects, the herein-described teachings can be extrapolated to determining adjustments to the current trajectory of a vehicle in response to detecting any road obstacles that can cause hazard to the second vehicle that is overtaking the first vehicle (e.g., wildlife in the road, pedestrians crossing the street, objects in the road).

In various instances, machine learning algorithms or models can be implemented in any suitable way to facilitate any suitable aspects described herein. To facilitate some of the above-described machine learning aspects of various embodiments, consider the following discussion of artificial intelligence (AI). Various embodiments described herein can employ artificial intelligence to facilitate automating one or more features or functionalities. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system or environment from a set of observations as captured via events or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events or data.

Such determinations can result in the construction of new events or actions from a set of observed events or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes or systems (e.g., support vector machines, neural networks, expert systems, Bayesian belief networks, fuzzy logic, data fusion engines, and so on) in connection with performing automatic or determined action in connection with the claimed subject matter. Thus, classification schemes or systems can be used to automatically learn and perform a number of functions, actions, or determinations.

A classifier can map an input attribute vector, z=(z₁, z₂, z₃, z₄, zₙ), to a confidence that the input belongs to a class, as by f (2)=confidence (class). Such classification can employ a probabilistic or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, or probabilistic classification models providing different patterns of independence, any of which can be employed. Classification as used herein also is inclusive of statistical regression that is utilized to develop models of priority.

The herein disclosure describes non-limiting examples. For case of description or explanation, various portions of the herein disclosure utilize the term “each,” “every,” or “all” when discussing various examples. Such usages of the term “each,” “every,” or “all” are non-limiting. In other words, when the herein disclosure provides a description that is applied to “each,” “every,” or “all” of some particular object or component, it should be understood that this is a non-limiting example, and it should be further understood that, in various other examples, it can be the case that such description applies to fewer than “each,” “every,” or “all” of that particular object or component.

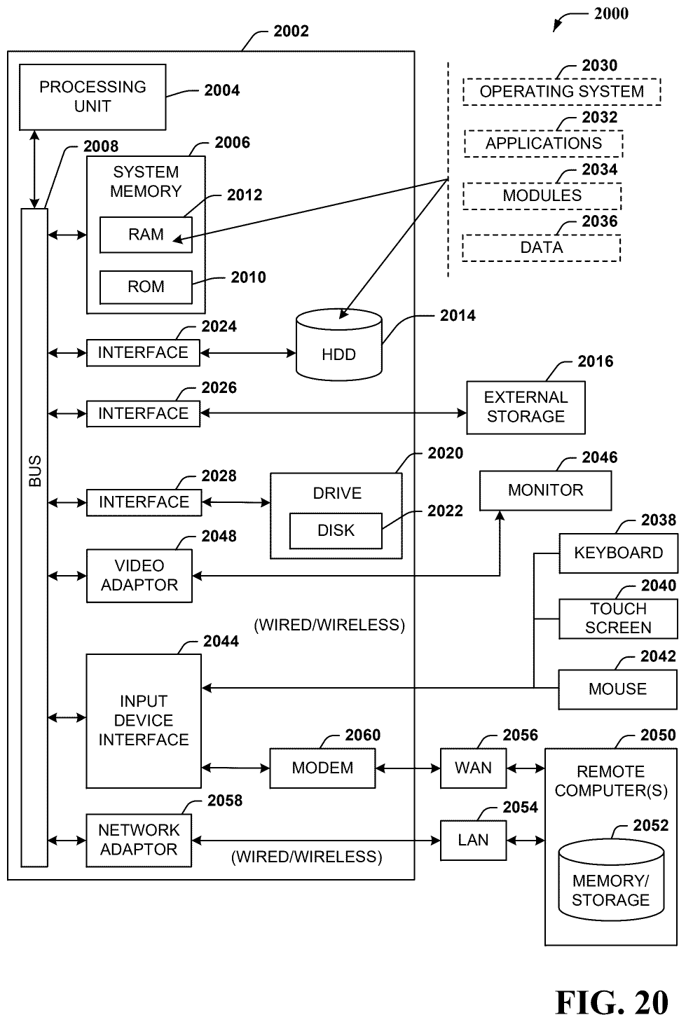

In order to provide additional context for various embodiments described herein, FIG. 20 and the following discussion are intended to provide a brief, general description of a suitable computing environment 2000 in which the various embodiments of the embodiment described herein can be implemented. While the embodiments have been described above in the general context of computer-executable instructions that can run on one or more computers, those skilled in the art will recognize that the embodiments can be also implemented in combination with other program modules or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multi-processor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 20, the example environment 2000 for implementing various embodiments of the aspects described herein includes a computer 2002, the computer 2002 including a processing unit 2004, a system memory 2006 and a system bus 2008. The system bus 2008 couples system components including, but not limited to, the system memory 2006 to the processing unit 2004. The processing unit 2004 can be any of various commercially available processors. Dual microprocessors and other multi-processor architectures can also be employed as the processing unit 2004.

The system bus 2008 can be any of several types of bus structure that can further interconnect to a memory bus (with or without a memory controller), a peripheral bus, and a local bus using any of a variety of commercially available bus architectures. The system memory 2006 includes ROM 2010 and RAM 2012. A basic input/output system (BIOS) can be stored in a non-volatile memory such as ROM, erasable programmable read only memory (EPROM), EEPROM, which BIOS contains the basic routines that help to transfer information between elements within the computer 2002, such as during startup. The RAM 2012 can also include a high-speed RAM such as static RAM for caching data.

The computer 2002 further includes an internal hard disk drive (HDD) 2014 (e.g., EIDE, SATA), one or more external storage devices 2016 (e.g., a magnetic floppy disk drive (FDD) 2016, a memory stick or flash drive reader, a memory card reader, etc.) and a drive 2020, e.g., such as a solid state drive, an optical disk drive, which can read or write from a disk 2022, such as a CD-ROM disc, a DVD, a BD, etc. Alternatively, where a solid state drive is involved, disk 2022 would not be included, unless separate. While the internal HDD 2014 is illustrated as located within the computer 2002, the internal HDD 2014 can also be configured for external use in a suitable chassis (not shown). Additionally, while not shown in environment 2000, a solid state drive (SSD) could be used in addition to, or in place of, an HDD 2014. The HDD 2014, external storage device(s) 2016 and drive 2020 can be connected to the system bus 2008 by an HDD interface 2024, an external storage interface 2026 and a drive interface 2028, respectively. The interface 2024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 2002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 2012, including an operating system 2030, one or more application programs 2032, other program modules 2034 and program data 2036. All or portions of the operating system, applications, modules, or data can also be cached in the RAM 2012. The systems and methods described herein can be implemented utilizing various commercially available operating systems or combinations of operating systems.

Computer 2002 can optionally comprise emulation technologies. For example, a hypervisor (not shown) or other intermediary can emulate a hardware environment for operating system 2030, and the emulated hardware can optionally be different from the hardware illustrated in FIG. 20. In such an embodiment, operating system 2030 can comprise one virtual machine (VM) of multiple VMs hosted at computer 2002. Furthermore, operating system 2030 can provide runtime environments, such as the Java runtime environment or the .NET framework, for applications 2032. Runtime environments are consistent execution environments that allow applications 2032 to run on any operating system that includes the runtime environment. Similarly, operating system 2030 can support containers, and applications 2032 can be in the form of containers, which are lightweight, standalone, executable packages of software that include, e.g., code, runtime, system tools, system libraries and settings for an application.

Further, computer 2002 can be enable with a security module, such as a trusted processing module (TPM). For instance with a TPM, boot components hash next in time boot components, and wait for a match of results to secured values, before loading a next boot component. This process can take place at any layer in the code execution stack of computer 2002, e.g., applied at the application execution level or at the operating system (OS) kernel level, thereby enabling security at any level of code execution.

A user can enter commands and information into the computer 2002 through one or more wired/wireless input devices, e.g., a keyboard 2038, a touch screen 2040, and a pointing device, such as a mouse 2042. Other input devices (not shown) can include a microphone, an infrared (IR) remote control, a radio frequency (RF) remote control, or other remote control, a joystick, a virtual reality controller or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 2004 through an input device interface 2044 that can be coupled to the system bus 2008, but can be connected by other interfaces, such as a parallel port, an IEEE 1394 serial port, a game port, a USB port, an IR interface, a BLUETOOTH® interface, etc.

A monitor 2046 or other type of display device can be also connected to the system bus 2008 via an interface, such as a video adapter 2048. In addition to the monitor 2046, a computer typically includes other peripheral output devices (not shown), such as speakers, printers, etc.

The computer 2002 can operate in a networked environment using logical connections via wired or wireless communications to one or more remote computers, such as a remote computer(s) 2050. The remote computer(s) 2050 can be a workstation, a server computer, a router, a personal computer, portable computer, microprocessor-based entertainment appliance, a peer device or other common network node, and typically includes many or all of the elements described relative to the computer 2002, although, for purposes of brevity, only a memory/storage device 2052 is illustrated. The logical connections depicted include wired/wireless connectivity to a local area network (LAN) 2054 or larger networks, e.g., a wide area network (WAN) 2056. Such LAN and WAN networking environments are commonplace in offices and companies, and facilitate enterprise-wide computer networks, such as intranets, all of which can connect to a global communications network, e.g., the Internet.

When used in a LAN networking environment, the computer 2002 can be connected to the local network 2054 through a wired or wireless communication network interface or adapter 2058. The adapter 2058 can facilitate wired or wireless communication to the LAN 2054, which can also include a wireless access point (AP) disposed thereon for communicating with the adapter 2058 in a wireless mode.

When used in a WAN networking environment, the computer 2002 can include a modem 2060 or can be connected to a communications server on the WAN 2056 via other means for establishing communications over the WAN 2056, such as by way of the Internet. The modem 2060, which can be internal or external and a wired or wireless device, can be connected to the system bus 2008 via the input device interface 2044. In a networked environment, program modules depicted relative to the computer 2002 or portions thereof, can be stored in the remote memory/storage device 2052. It will be appreciated that the network connections shown are example and other means of establishing a communications link between the computers can be used.

When used in either a LAN or WAN networking environment, the computer 2002 can access cloud storage systems or other network-based storage systems in addition to, or in place of, external storage devices 2016 as described above, such as but not limited to a network virtual machine providing one or more aspects of storage or processing of information. Generally, a connection between the computer 2002 and a cloud storage system can be established over a LAN 2054 or WAN 2056 e.g., by the adapter 2058 or modem 2060, respectively. Upon connecting the computer 2002 to an associated cloud storage system, the external storage interface 2026 can, with the aid of the adapter 2058 or modem 2060, manage storage provided by the cloud storage system as it would other types of external storage. For instance, the external storage interface 2026 can be configured to provide access to cloud storage sources as if those sources were physically connected to the computer 2002.

The computer 2002 can be operable to communicate with any wireless devices or entities operatively disposed in wireless communication, e.g., a printer, scanner, desktop or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

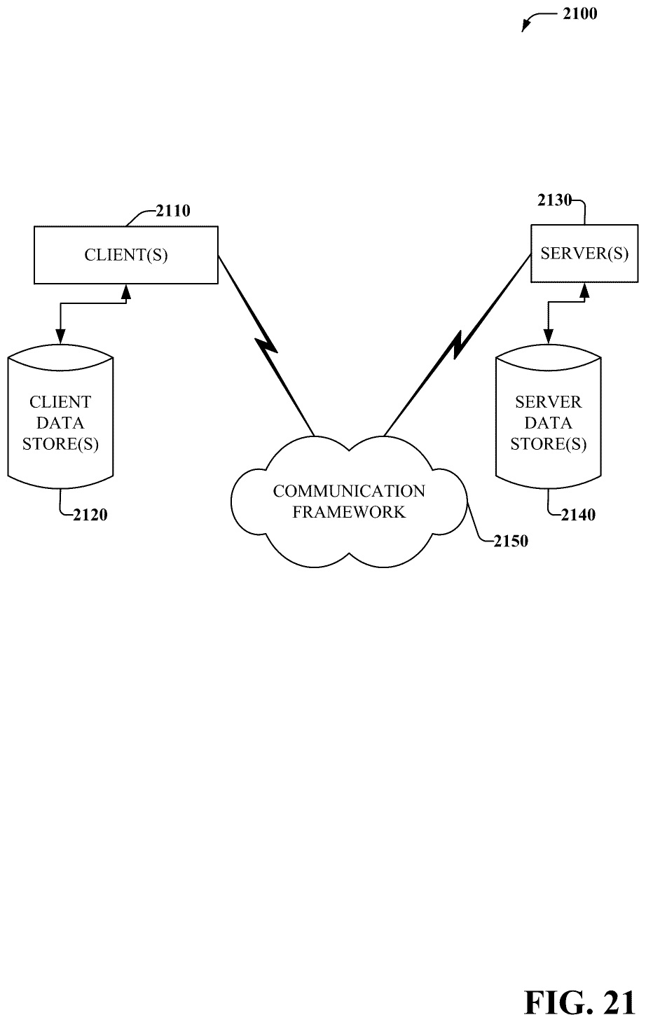

FIG. 21 is a schematic block diagram of a sample computing environment 2100 with which the disclosed subject matter can interact. The sample computing environment 2100 includes one or more client(s) 2110. The client(s) 2110 can be hardware or software (e.g., threads, processes, computing devices). The sample computing environment 2100 also includes one or more server(s) 2130. The server(s) 2130 can also be hardware or software (e.g., threads, processes, computing devices). The servers 2130 can house threads to perform transformations by employing one or more embodiments as described herein, for example. One possible communication between a client 2110 and a server 2130 can be in the form of a data packet adapted to be transmitted between two or more computer processes. The sample computing environment 2100 includes a communication framework 2150 that can be employed to facilitate communications between the client(s) 2110 and the server(s) 2130. The client(s) 2110 are operably connected to one or more client data store(s) 2120 that can be employed to store information local to the client(s) 2110. Similarly, the server(s) 2130 are operably connected to one or more server data store(s) 2140 that can be employed to store information local to the servers 2130.

The present invention may be a system, a method, an apparatus or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations or block diagrams of methods, apparatus (systems), and computer program products according to embodiments of the invention. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus, or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that this disclosure also can or can be implemented in combination with other program modules. Generally, program modules include routines, programs, components, data structures, etc. that perform particular tasks or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system, or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter disclosed herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various non-limiting aspects of various embodiments described herein are presented in the following clauses.

Clause 1: A system onboard a first vehicle operating in at least a partially autonomous manner, comprising: a memory that stores computer executable components; and a processor that executes the computer executable components stored in the memory, wherein the computer executable components comprise: a recognition component that detects, via one or more sensors onboard the first vehicle, overtaking intention by a second vehicle of the first vehicle; and an adaptation component that determines, in response to detection of the overtaking intention by the second vehicle, adjustments of a current trajectory of the first vehicle to facilitate completion of overtaking by the second vehicle or deter overtaking by the second vehicle.

Clause 2: The system of any preceding clause, wherein the recognition component detects overtaking intention by the second vehicle based on one or more states of the second vehicle, wherein the one or more states of the second vehicle comprise at least one of: in-lane positions, heading, velocity, acceleration, or activation of turn signals.

Clause 3: The system of any preceding clause, wherein the recognition component determines the adjustments of the current trajectory based on the one or more states of the second vehicle.

Clause 4: The system of any preceding clause, wherein the recognition component detects, via the one or more sensors, oncoming vehicles and estimates one or more states of the oncoming vehicles, wherein the one or more states of the oncoming vehicles comprise at least one of: velocity, acceleration, longitudinal position relative to the first vehicle, lateral position relative to the first vehicle, or environment conditions.

Clause 5: The system of any preceding clause, wherein the recognition component determines the adjustments of the current trajectory based on the one or more states of the oncoming vehicles.

Clause 6: The system of any preceding clause, wherein the recognition component tracks, via the one or more sensors and in response to detection of the overtaking intention by the second vehicle, the second vehicle until completion or deterrence of overtaking by the second vehicle.

Clause 7: The system of any preceding clause, wherein the adjustments of the current trajectory comprise at least one of: adjustments to lateral movement, deceleration of the first vehicle, or acceleration of the first vehicle.

Clause 8: The system of any preceding clause, wherein the computer-executable components further comprise: a control component that generates acceleration requests to adjust operation of the first vehicle in accordance with the adjustments of the current trajectory.

Clause 9: The system of any preceding clause, wherein the computer-executable components further comprise: a network component that communicates, via Vehicle-to-Vehicle (V2V) communication, with the oncoming vehicles to request deceleration of the oncoming vehicles

Clause 10: The system of any preceding clause, wherein the computer-executable components further comprise: an inference component that infers a risk level of the oncoming vehicles and does not trigger the adjustments of the current trajectory in response to an inference that there is no risk from the oncoming vehicles.

In various cases, any suitable combination or combinations of clauses 1-10 can be implemented.

Clause 11: A computer-implemented method, comprising: detecting, by a system onboard a first vehicle and comprising a processor, overtaking intention by a second vehicle of the first vehicle via one or more sensors onboard the first vehicle; and determining, by the system and in response to detection of the overtaking intention by the second vehicle, adjustments of a current trajectory of the first vehicle to facilitate completion of overtaking by the second vehicle or deter overtaking by the second vehicle.

Clause 12: The computer-implemented method of any preceding clause, further comprising: detecting, by the system, overtaking intention by the second vehicle based on one or more states of the second vehicle, wherein the one or more states of the second vehicle comprise at least one of: in-lane positions, heading, velocity, acceleration, or activation of turn signals.

Clause 13: The computer-implemented method of any preceding clause, further comprising: detecting, by the system and via the one or more sensors, oncoming vehicles and estimates one or more states of the oncoming vehicles, wherein the one or more states of the oncoming vehicles comprise at least one of: velocity, acceleration, longitudinal position relative to the first vehicle, lateral position relative to the first vehicle, or environment conditions.

Clause 14: The computer-implemented method of any preceding clause, wherein the adjustments of the current trajectory comprise at least one of: adjustments to lateral movement, deceleration of the first vehicle, or acceleration of the first vehicle.

Clause 15: The computer-implemented method of any preceding clause, further comprising: generating, by the system, acceleration requests to adjust operation of the first vehicle in accordance with the adjustments of the current trajectory.

Clause 16: The computer-implemented method of any preceding clause, further comprising: communicating, by the system and via Vehicle-to-Vehicle (V2V) communication, with the oncoming vehicles to request deceleration of the oncoming vehicles.

In various cases, any suitable combination or combinations of clauses 11-16 can be implemented.

Clause 17: A computer program product for facilitating artificially intelligent assistance of hazardous overtaking initiatives, the computer program product comprising a non-transitory computer-readable memory having program instructions embodied therewith, the program instructions executable by a processor onboard a first vehicle to cause the processor to: detect, via one or more sensors onboard the first vehicle, overtaking intention by a second vehicle of the first vehicle; and determine, in response to detection of the overtaking intention by the second vehicle, adjustments of a current trajectory of the first vehicle to facilitate completion of overtaking by the second vehicle or deter overtaking by the second vehicle.

Clause 18: The computer program product of any preceding clause, wherein the program instructions are further executable to cause the processor to: detect overtaking intention by the second vehicle based on one or more states of the second vehicle, wherein the one or more states of the second vehicle comprise at least one of: in-lane positions, heading, velocity, acceleration, or activation of turn signals.

Clause 19: The computer program product of any preceding clause, wherein the program instructions are further executable to cause the processor to: detect, via the one or more sensors, oncoming vehicles and estimates one or more states of the oncoming vehicles, wherein the one or more states of the oncoming vehicles comprise at least one of: velocity, acceleration, longitudinal position relative to the first vehicle, lateral position relative to the first vehicle, or environment conditions.

Clause 20: The computer program product of any preceding clause, wherein the adjustments of the current trajectory comprise at least one of: adjustments to lateral movement, deceleration of the first vehicle, or acceleration of the first vehicle.

In various cases, any suitable combination or combinations of clauses 17-20 can be implemented.

In various cases, any suitable combination or combinations of clauses 1-20 can be implemented.

What is claimed is:

1. A system onboard a first vehicle operating in at least a partially autonomous manner, comprising:
a memory that stores computer executable components; and
a processor that executes the computer executable components stored in the memory, wherein the computer executable components comprise:
a recognition component that detects, via one or more sensors onboard the first vehicle, overtaking intention by a second vehicle of the first vehicle; and
an adaptation component that determines, in response to detection of the overtaking intention by the second vehicle, adjustments of a current trajectory of the first vehicle to facilitate completion of overtaking by the second vehicle or deter overtaking by the second vehicle.

2. The system of claim 1, wherein the recognition component detects overtaking intention by the second vehicle based on one or more states of the second vehicle, wherein the one or more states of the second vehicle comprise at least one of: in-lane positions, heading, velocity, acceleration, or activation of turn signals.

3. The system of claim 2, wherein the recognition component determines the adjustments of the current trajectory based on the one or more states of the second vehicle.

4. The system of claim 1, wherein the recognition component detects, via the one or more sensors, oncoming vehicles and estimates one or more states of the oncoming vehicles, wherein the one or more states of the oncoming vehicles comprise at least one of: velocity, acceleration, longitudinal position relative to the first vehicle, lateral position relative to the first vehicle, or environment conditions.

5. The system of claim 4, wherein the recognition component determines the adjustments of the current trajectory based on the one or more states of the oncoming vehicles.

6. The system of claim 1, wherein the recognition component tracks, via the one or more sensors and in response to detection of the overtaking intention by the second vehicle, the second vehicle until completion or deterrence of overtaking by the second vehicle.

7. The system of claim 1, wherein the adjustments of the current trajectory comprise at least one of: adjustments to lateral movement, deceleration of the first vehicle, or acceleration of the first vehicle.

8. The system of claim 1, wherein the computer-executable components further comprise:
a control component that generates acceleration requests to adjust operation of the first vehicle in accordance with the adjustments of the current trajectory.

9. The system of claim 4, wherein the computer-executable components further comprise:
a network component that communicates, via Vehicle-to-Vehicle (V2V) communication, with the oncoming vehicles to request deceleration of the oncoming vehicles.

10. The system of claim 4, wherein the computer-executable components further comprise:
an inference component that infers a risk level of the oncoming vehicles and does not trigger the adjustments of the current trajectory in response to an inference that there is no risk from the oncoming vehicles.

11. A computer-implemented method, comprising:
detecting, by a system onboard a first vehicle and comprising a processor, overtaking intention by a second vehicle of the first vehicle via one or more sensors onboard the first vehicle; and
determining, by the system and in response to detection of the overtaking intention by the second vehicle, adjustments of a current trajectory of the first vehicle to facilitate completion of overtaking by the second vehicle or deter overtaking by the second vehicle.

12. The computer-implemented method of claim 11, further comprising:
detecting, by the system, overtaking intention by the second vehicle based on one or more states of the second vehicle, wherein the one or more states of the second vehicle comprise at least one of: in-lane positions, heading, velocity, acceleration, or activation of turn signals.

13. The computer-implemented method of claim 11, further comprising:
detecting, by the system and via the one or more sensors, oncoming vehicles and estimates one or more states of the oncoming vehicles, wherein the one or more states of the oncoming vehicles comprise at least one of: velocity, acceleration, longitudinal position relative to the first vehicle, lateral position relative to the first vehicle, or environment conditions.

14. The computer-implemented method of claim 11, wherein the adjustments of the current trajectory comprise at least one of: adjustments to lateral movement, deceleration of the first vehicle, or acceleration of the first vehicle.

15. The computer-implemented method of claim 11, further comprising:
generating, by the system, acceleration requests to adjust operation of the first vehicle in accordance with the adjustments of the current trajectory.

16. The computer-implemented method of claim 13, further comprising:
communicating, by the system and via Vehicle-to-Vehicle (V2V) communication, with the oncoming vehicles to request deceleration of the oncoming vehicles.

17. A computer program product for facilitating artificially intelligent assistance of hazardous overtaking initiatives, the computer program product comprising a non-transitory computer-readable memory having program instructions embodied therewith, the program instructions executable by a processor onboard a first vehicle to cause the processor to:
detect, via one or more sensors onboard the first vehicle, overtaking intention by a second vehicle of the first vehicle; and
determine, in response to detection of the overtaking intention by the second vehicle, adjustments of a current trajectory of the first vehicle to facilitate completion of overtaking by the second vehicle or deter overtaking by the second vehicle.

18. The computer program product of claim 17, wherein the program instructions are further executable to cause the processor to:
detect overtaking intention by the second vehicle based on one or more states of the second vehicle, wherein the one or more states of the second vehicle comprise at least one of: in-lane positions, heading, velocity, acceleration, or activation of turn signals.

19. The computer program product of claim 17, wherein the program instructions are further executable to cause the processor to:
detect, via the one or more sensors, oncoming vehicles and estimates one or more states of the oncoming vehicles, wherein the one or more states of the oncoming vehicles comprise at least one of: velocity, acceleration, longitudinal position relative to the first vehicle, lateral position relative to the first vehicle, or environment conditions.

20. The computer program product of claim 17, wherein the adjustments of the current trajectory comprise at least one of: adjustments to lateral movement, deceleration of the first vehicle, or acceleration of the first vehicle.
